(19) United States
(12) Patent Application Publication
(10) Pub. No.: US 2024/0338513 A1
(43) Pub. Date: Oct. 10, 2024

(54) DISPLAY APPARATUS

(71) Applicant: VIDAA (NETHERLANDS) INTERNATIONAL HOLDINGS B.V., Duiven (NL)

(72) Inventors: Baiping LI, Duiven (NL); Guixiu ZENG, Duiven (NL); Congpeng ZHANG, Duiven (NL); Futeng NIU, Duiven (NL)

(21) Appl. No.: 18/749,453

(22) Filed: Jun. 20, 2024

Related U.S. Application Data
(63) Continuation of application No. PCT/EP2023/058324, filed on Mar. 30, 2023.

(30) Foreign Application Priority Data
Apr. 1, 2022 (CN) 202210347317.7
Jun. 24, 2022 (CN) 202210728692.6

(51) Int. Cl. G06F 40/106; G06F 40/109; G06F 40/221

(52) U.S. Cl. CPC G06F 40/106; G06F 40/109; G06F 40/221

(57) ABSTRACT

A display apparatus and a method for processing a web page are disclosed. The method includes: in response to a first command for opening a first browser application in the display apparatus input from a user, starting to load a first web page of the first browser application; parsing the first web page downloaded, to obtain a first document object model tree; in response to a web page head of the first document object model tree including a first meta viewport tag, determining a first resolution of the first web page according to the first meta viewport tag; determining a first web page scale factor according to a physical resolution of the display apparatus and the first resolution; relayouting, redrawing, and rearranging an element on the first web page based on the first web page scale factor to determine a second web page; and presenting the second web page.

### CROSS-REFERENCE OF RELATED APPLICATIONS

This application is a continuation application of International Application No. PCT/EP2023/058324, filed on Mar. 30, 2023, which claims priorities to Chinese Patent Application No. 202210347317.7 filed on Apr. 1, 2022, and Chinese Patent Application No. 202210728692.6 filed on Jun. 24, 2022, all of which are hereby incorporated by reference in their entireties.

### FIELD

The disclosure relates to the field of display apparatus technologies, and particularly to a display apparatus and a processing method for a display apparatus.

### BACKGROUND

Now many browser applications may be installed in a display apparatus. For example, an HbbTV (Hybrid Broadcast/Broadband TV) application, a Store application, and an Open browser web page application may all be installed in the display apparatus. However, different browser applications have different web page rendering resolutions. For example, the HbbTV application has a web page rendering resolution of 720p; the Store application has web page rendering resolutions of 720p and 1080i; and the Open browser web page application has a web page rendering resolution of 1080i. Different web page rendering resolutions of a same browser application may also differ. The above two differences may lead to picture flicker during switching between applications with different resolutions or switching between pages with different resolutions of a same application, a small region of a screen rendering all web page contents, or a full screen presenting a part of the web page contents. When a low-resolution application is presented on a screen with a high physical resolution, the low-resolution application is directly stretched at a back end of the rendering, or when a high-resolution application is presented on a screen with a low physical resolution, the high-resolution application is directly compressed at a back end of the rendering, thereby resulting in blurred pictures and poor user experience.

### SUMMARY

Some embodiments of the disclosure provide a display apparatus, including: a display configured to display an image from a broadcasting system or a network, and/or, a user interface; and a communicating device configured to communicate with the network; at least one processor in connection with the display and the communicating device and configured to execute instructions to cause the display apparatus to: in response to a first command for opening a first browser application in the display apparatus from a user, start to load a first web page of the first browser application; parse the first web page downloaded, to obtain a first document object model tree; in response to a web page head of the first document object model tree including a first meta viewport tag, determine a first resolution of the first web page according to the first meta viewport tag; determine a first web page scale factor according to a physical resolution of the display apparatus and the first resolution; relayout, redraw, and rearrange an element on the first web page based on the first web page scale factor to determine a second web page; and cause the display to present the second web page; where the at least one processor is further configured to execute instructions to cause the display apparatus to: in response to the element on the first web page being a text control, determine a first coordinate of a specific point of the text control and a first font size of a text on the text control, the specific point including a center point or a vertex of the text control; determine a second coordinate of the specific point of the text control according to the first coordinate of the specific point of the text control and the first web page scale factor; determine a second font size of the text according to the first font size of the text and the first web page scale factor; and draw the text control according to the second coordinate and the second font size.

Some embodiments of the disclosure provide a method for processing a web page in a display apparatus, including: in response to a first command for opening a first browser application in the display apparatus input from a user, starting to load a first web page of the first browser application; parsing the first web page downloaded, to obtain a first document object model tree; in response to a web page head of the first document object model tree including a first meta viewport tag, determining a first resolution of the first web page according to the first meta viewport tag; determining a first web page scale factor according to a physical resolution of the display apparatus and the first resolution; relayouting, redrawing, and rearranging an element on the first web page based on the first web page scale factor to determine a second web page; and causing a display to present the second web page; where the relayouting, redrawing, and rearranging the element on the first web page includes: in response to the element on the first web page being a text control, determining a first coordinate of a specific point of the text control and a first font size of a text on the text control, the specific point including a center point or a vertex of the text control; determining a second coordinate of the specific point of the text control according to the first coordinate of the specific point of the text control and the first web page scale factor; determining a second font size of the text according to the first font size of the text and the first web page scale factor; and drawing the text control according to the second coordinate and the second font size.

### BRIEF DESCRIPTION OF THE DRAWINGS

FIG. 1 is an operation scenario between a display apparatus and a control device according to some embodiments;

FIG. 2 is a block diagram of a hardware configuration of a control device 100 according to some embodiments;

FIG. 3 is a block diagram of a hardware configuration of a display apparatus 200 according to some embodiments;

FIG. 4 is a software configuration diagram in the display apparatus 200 according to some embodiments;

FIG. 5 is a flowchart of a processor according to some embodiments;

FIG. 6 is a schematic diagram of a user interface according to some embodiments;

FIG. 7 is a schematic diagram of a user interface according to some embodiments;

FIG. 8 is a schematic diagram of a user interface according to some embodiments;

FIG. 9 is a schematic diagram of a home page according to some embodiments;

FIG. 10 is a schematic diagram of an animation recommendation page of a first browser application according to some embodiments;

FIG. 11 is a schematic diagram of a coordinate system according to some embodiments;

FIG. 12 is a schematic control layout diagram of a first web page according to some embodiments;

FIG. 13 is a schematic control layout diagram of a second web page according to some embodiments;

FIG. 14 is a schematic control layout diagram of a first web page according to some embodiments;

FIG. 15 is a schematic control layout diagram of a second web page according to some embodiments;

FIG. 16 is a schematic control layout diagram of a first web page according to some embodiments;

FIG. 17 is a schematic control layout diagram of a second web page according to some embodiments;

FIG. 18 is a schematic control layout diagram of a first web page according to some embodiments;

FIG. 19 is a schematic control layout diagram of a second web page according to some embodiments;

FIG. 20 is a schematic diagram of a user interface during application switching according to some embodiments;

FIG. 21 is a schematic diagram of a user interface during application switching according to some embodiments;

FIG. 22 is a schematic diagram of presenting a same focus for multiple control devices in connection with a display apparatus in an embodiment of the disclosure;

FIG. 23 is a schematic flowchart of controlling a window of a same browser for multiple devices based on multiple focuses in an embodiment of the disclosure;

FIG. 24 is a schematic diagram of presenting a first focus for multiple control devices in connection with a display apparatus correspondingly when a multi-device control function is not activated in an embodiment of the disclosure;

FIG. 25 is a schematic diagram of a setting menu in an embodiment of the disclosure;

FIG. 26 is a schematic diagram of a control device list in an embodiment of the disclosure;

FIG. 27 is a schematic diagram of presenting respective focuses for multiple control devices in connection with a display apparatus correspondingly when a multi-device control function is activated in an embodiment of the disclosure;

FIG. 28 is a schematic diagram of presenting respective focuses for multiple control devices in connection with a display apparatus correspondingly when a multi-device control function is activated in an embodiment of the disclosure;

FIG. 29 is a schematic diagram of presenting respective focuses for multiple control devices in connection with a display apparatus correspondingly when a multi-device control function is activated in an embodiment of the disclosure;

FIG. 30 is a schematic diagram of hiding a focus in an idle state among multiple focuses in an embodiment of the disclosure;

FIG. 31 is a schematic flowchart of controlling move of each focus among multiple focuses on a user interface of a browser in an embodiment of the disclosure;

FIG. 32 is a schematic diagram of presenting a first focus at a boundary of a user interface of a browser when coordinate of the first focus moves beyond the boundary in an embodiment of the disclosure;

FIG. 33 is a schematic flowchart of responding to simultaneously received commands according to a response priority in an embodiment of the disclosure;

FIG. 34 is a schematic diagram of simultaneously commands to a browser from a first control device based on a first focus and from a control device A based on a focus A in an embodiment of the disclosure;

FIG. 35 is a schematic diagram of presenting a browser page according to a response priority in an embodiment of the disclosure;

FIG. 36 is a schematic flowchart of controlling a browser for multiple devices based on multiple focuses through a combined command in an embodiment of the disclosure;

FIG. 37 is a schematic diagram of distance measurement between two points based on double focuses in an embodiment of the disclosure;

FIG. 38 is a schematic diagram of 3D rotation based on double focuses in an embodiment of the disclosure;

FIG. 39 is a schematic flowchart of controlling each window after screen splitting of a browser respectively for multiple devices based on multiple focuses in an embodiment of the disclosure;

FIG. 40 is a schematic diagram of presenting focuses of a plurality of connected control devices respectively in each window when a screen splitting function is activated in an embodiment of the disclosure;

FIG. 41 is a schematic diagram of presenting move of each focus within a corresponding window to a window boundary in an embodiment of the disclosure;

FIG. 42 is a schematic flowchart of controlling a third focus to move from a specified region into a target window in an embodiment of the disclosure;

FIG. 43 is a schematic diagram of presenting respective focuses when the third focus is within the specified region in an embodiment of the disclosure;

FIG. 44 is a schematic diagram of presenting respective focuses when the third focus is within the target window in an embodiment of the disclosure; and

FIG. 45 is a schematic flowchart of controlling the third focus to move from the target window into the specified region in an embodiment of the disclosure.

### DETAILED DESCRIPTION OF EMBODIMENTS

In order to make purposes and embodiments of the disclosure clearer, embodiments of the disclosure will be described clearly and completely below in combination with the accompanying drawings in embodiments of the disclosure. Obviously, the described embodiments are some but not all embodiments of the disclosure.

It should be noted that the brief description of the terms in the disclosure is only for the convenience of understanding embodiments described hereafter, and is not intended to limit embodiments of the disclosure. Unless otherwise specified, these terms should be understood according to the ordinary and plain meanings.

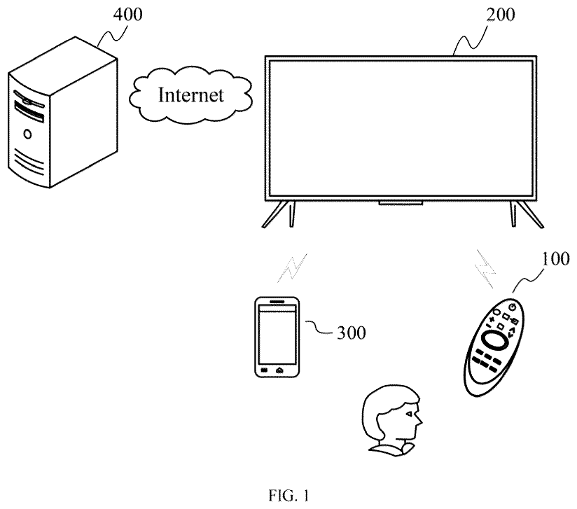

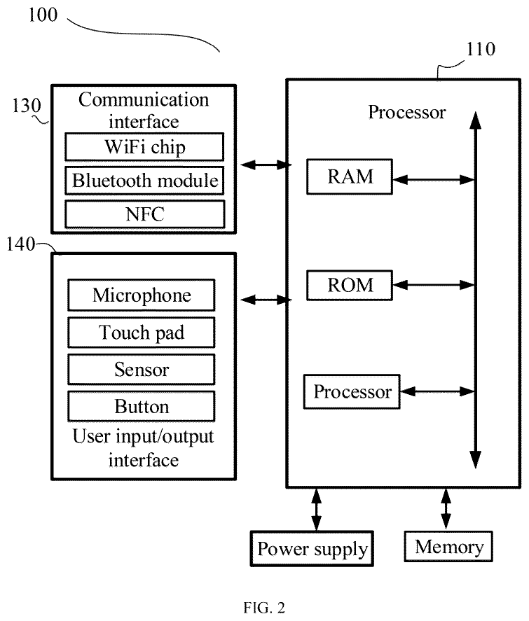

The display apparatus according to embodiments of the disclosure may have various implementations, such as a TV, a smart TV, a laser projection apparatus, a monitor, an electronic bulletin board, an electronic table, etc. FIG. 1 and FIG. 2 are specific embodiments of a display apparatus in the disclosure.

FIG. 1 is a schematic diagram of an operation scenario between a display apparatus and a control device according to embodiments. As shown in FIG. 1, a user may operate a display apparatus 200 through a smart device 300 or a control device 100.

In some embodiments, the control device 100 may be a remote control, and the communication between the remote control and the display apparatus includes infrared protocol communication or Bluetooth protocol communication and other short-range communication methods. The display apparatus 200 is controlled wirelessly or by wired methods. The user may control the display apparatus 200 by inputting a user command through a button on the remote control, voice input, control panel input, etc.

In some embodiments, the smart device 300 (e.g., a mobile terminal, a tablet computer, a computer, a notebook computer, etc.) may also be configured to control the display apparatus 200. For example, an application running on the smart device is configured to control the display apparatus 200.

In some embodiments, the display apparatus may receive a command without using the above smart device or control device, but receive user control by, e.g., touch or gesture.

In some embodiments, the display apparatus 200 may also be controlled by means other than the control device 100 and the smart device 300, for example, may directly receive a voice command from a user via a voice command acquiring module provided inside the display apparatus 200, or may receive a voice command from a user via a voice control device provided outside the display apparatus 200.

In some embodiments, the display apparatus 200 also performs data communication with a server 400. The display apparatus 200 may be allowed to perform communication and connection through a Local Area Network (LAN), a Wireless Local Area Network (WLAN), and other networks. The server 400 may provide various contents and interactions for the display apparatus 200.

The server 400 may be a server providing various services, such as a backend server providing support for voice data collected by the display apparatus 200. The backend server may process, e.g., analyze, data, such as received audio, and return the processing result to a terminal apparatus.

FIG. 2 is a block diagram of the configuration of the control device 100 according to embodiments. As shown in FIG. 2, the control device 100 includes a processor 110, a communication interface 130, a user input/output interface 140, a memory, and a power supply. The control device 100 may receive an operation command input from a user and convert the operation command into an instruction that can be recognized and responded by the display apparatus 200, playing an intermediary role between the user and the display apparatus 200.

As shown in FIG. 3, the display apparatus 200 includes at least one of a tuning demodulator 210, a communicator 220, a detector 230, an external device interface 240, a processor 250, a display 260, an audio output interface 270, a memory, a power supply, or a user interface.

In some embodiments, the processor includes a processor, a video processor, an audio processor, a graphics processor, a RAM, a ROM, and first to n^{th} interfaces for input/output.

The display 260 includes a display screen component for presenting an image, a driver component for driving image display, a component for receiving an image signal output from the processor, and for presenting a video content, image content, and a menu manipulation interface, and a UI for user manipulation.

The display 260 may be a liquid crystal display, an OLED display, and a projection display, or may be a projection device and a projection screen.

The communicator 220 is a component for communicating with an external apparatus or server according to various types of communication protocols. For example, the communicator may include at least one of a Wifi module, a Bluetooth module, a wired Ethernet module, other network communication protocol chip or near-field communication protocol chip, or an infrared receiver. The display apparatus 200 may send and receive control signals and data signals with the external control device 100 or the server 400 through the communicator 220.

The user input interface may be configured to receive a control signal from the control device 100 (e.g., infrared remote control, etc.).

The detector 230 is configured to collect a signal from an external environment or external interaction. For example, the detector 230 includes an optical receiver and a sensor for collecting ambient light intensity; or, the detector 230 includes an image collector, such as a camera, which may be configured to collect an external environment scenario, a user attribute, or a user interaction gesture, or the detector 230 includes a sound collector, such as a microphone, which is configured to receive an external sound.

The sound collector may be a microphone, which may be configured to receive a user voice, and convert a sound signal into an electrical signal. The display apparatus 200 may be equipped with at least one microphone. In other embodiments, the display apparatus 200 may be equipped with two microphones, to not only collect sound signals, but also implement the noise reduction function. In other embodiments, the display apparatus 200 may also be equipped with three, four or more microphones, to collect sound signals, reduce noises, identify sound sources, and implement the directional recording function.

In addition, the microphone may be built in the display apparatus 200, or the microphone may be connected with the display apparatus 200 by wired methods or wirelessly. Of course, in embodiments of the disclosure, a position of the microphone on the display apparatus 200 is not limited. Alternatively, the display apparatus 200 may not include a microphone, i.e., the above microphone is not provided in the display apparatus 200. The display apparatus 200 may be connected with a microphone through an interface (such as a USB interface 130). The external microphone may be fixed on the display apparatus 200 by external fasteners (such as a camera bracket with a clip).

The external device interface 240 may include, but is not limited to, any one or more of a High-Definition Multimedia Interface (HDMI), an analog or data high-definition component input interface (Component), a Composite Video Broadcast Signal (CVBS) input interface, a USB input interface (USB), or an RGB terminal, or may be a composite input/output interface formed by a plurality of interfaces mentioned above.

The tuning demodulator 210 receives broadcast system signals through a wired or wireless manner, and demodulates audio and video signals, such as EPG data signals, from a plurality of wireless or wired broadcast television signals.

In some embodiments, the processor 250 and the tuning demodulator 210 may be located in different separate devices, that is, the tuning demodulator 210 may also be located in an external device (such as an external set-top box, etc.) of a main device where the processor 250 is located.

The processor 250 controls operations of the display apparatus and responds to the user's operations through various software programs stored in the memory. The processor 250 controls the overall operation of the display apparatus 200. For example, in response to receiving a user command for selecting a UI object presented on the display 260, the processor 250 may perform an operation associated with the object selected based on the user command.

In some embodiments, the processor includes at least one of a Central Processing Unit (CPU), a video processor, an audio processor, a Graphics Processing Unit (GPU), a Random Access Memory (RAM), a Read-Only Memory (ROM), first to n^{th} interfaces for input/output, a communication bus (Bus), etc.

The user may input the user command on a graphical user interface (GUI) presented on the display 260, and the user input interface receives the input user command through the graphical user interface (GUI). Alternatively, the user may input the user command by inputting a specific voice or gesture, and the user input interface recognizes the voice or gesture through a sensor to receive the input user command.

In some embodiments, the display 260 includes a panel component for presenting an image, a driver component for driving image display, a component for receiving an image signal output from the controller 250, and for presenting a video content, image content, and a menu operation interface, and a UI for user operation.

The display 260 may be a liquid crystal display, an OLED display, and a projection display, or may be a projection device and a projection screen.

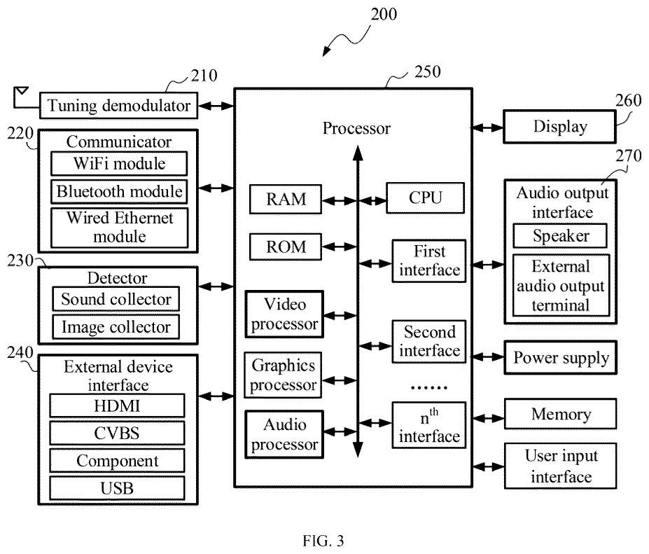

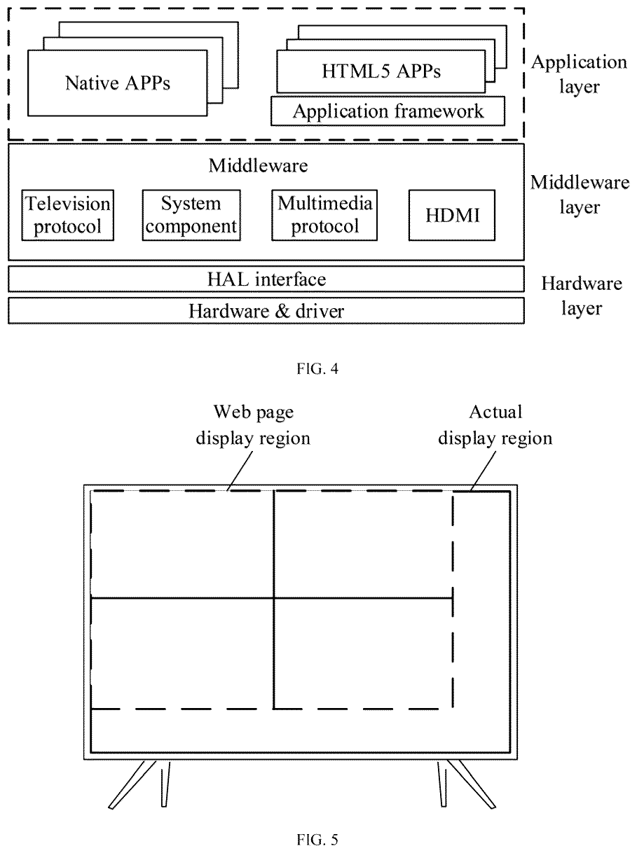

In some embodiments, the display apparatus 200 is based on a VIDAA software platform. As shown in FIG. 4, the system of the display apparatus may include a kernel, a command parser (shell), a document system, and an application. The kernel, the shell, and the document system together form a basic operating system structure, and allow the user to manage documents, run applications, and use the system. After being powered on, the kernel is started to activate kernel space, abstract hardware, initialize hardware parameters, and run and maintain virtual memory, scheduler, signals, and interprocess communication (IPC). After the kernel is started, the shell and user applications are loaded. The applications are compiled into machine codes after startup, forming processes.

As shown in FIG. 4, the system of the display apparatus is divided into three layers, which are respectively an application layer, a middleware layer, and a hardware layer from top to bottom.

The application layer mainly includes applications on television and Application Framework. The applications are mainly applications developed based on Browser, such as: HTML5 APPs; and native applications (Native APPs).

The Application Framework is a complete program model, with all basic functions required by the standard application software, such as: document access, data exchange, . . . , and use interfaces (toolbar, status bar, menu, dialog) of these functions.

The Native APPs can support online or offline work, message push or local resource access.

The middleware layer includes middleware such as various television protocols, multimedia protocols and system components. The middleware can use basic services (functions) provided by the system software to connect various parts of the application system or different applications on the network, and can achieve resource sharing and function sharing.

The hardware layer mainly includes an HAL interface, hardware, and drivers. The HAL interface is a unified interface for all television chips, and the specific logic is implemented by each chip. The drivers mainly include: audio driver, panel driver, Bluetooth driver, camera driver, WIFI driver, USB driver, HDMI driver, sensor driver (such as fingerprint sensor, temperature sensor, pressure sensor, etc.), and power driver, etc.

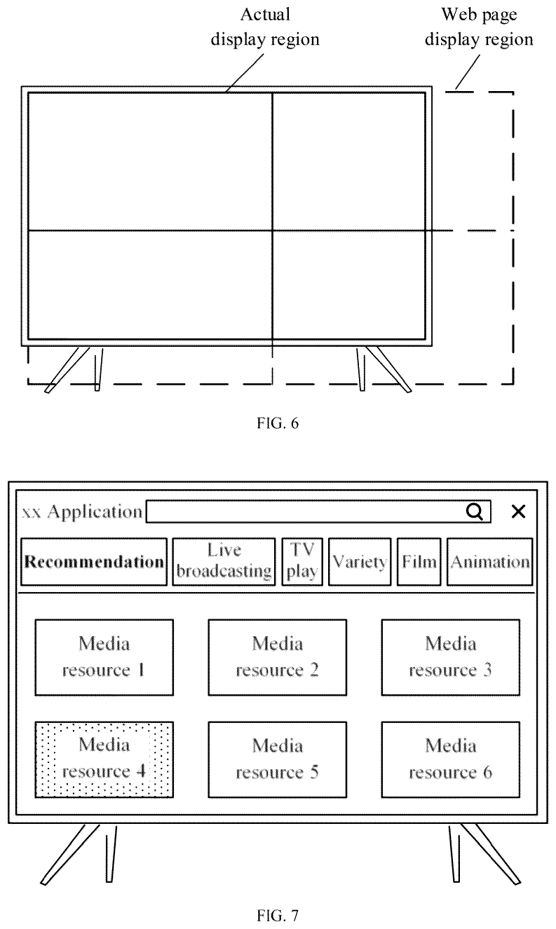

Many browser applications can be installed in a display apparatus. For example, an HbbTV application, a Store application, and an Open browser web page application may all be installed in a television. However, different browser applications have different web page rendering resolutions. For example, the HbbTV application has a web page rendering resolution of 720p; the Store application has web page rendering resolutions of 720p and 1080i; and the Open browser web page application has a web page rendering resolution of 1080i. Different web page rendering resolutions of a same browser application may also differ. In some embodiments, the web page rendering resolution of the browser application is greater than a physical resolution of the display apparatus, such that a full screen may present a portion of content on the web page, as shown in FIG. 6; and the web page rendering resolution of the browser application is less than the physical resolution of the display apparatus, such that a small region of the screen may render all web page contents, as shown in FIG. 5. In some embodiments, when the web page rendering resolution of the browser application is greater than the physical resolution of the display apparatus, a browser application web page is directly compressed and presented in an algorithm layer; and when the web page rendering resolution of the browser application is less than the physical resolution of the display apparatus, the browser application web page is directly stretched and presented in the algorithm layer. By directly compressing, stretching, and presenting a rendered web page, the full screen can be filled, but stretch or compression will lead to blurred pictures, as shown in FIG. 7, thereby affecting normal image display.

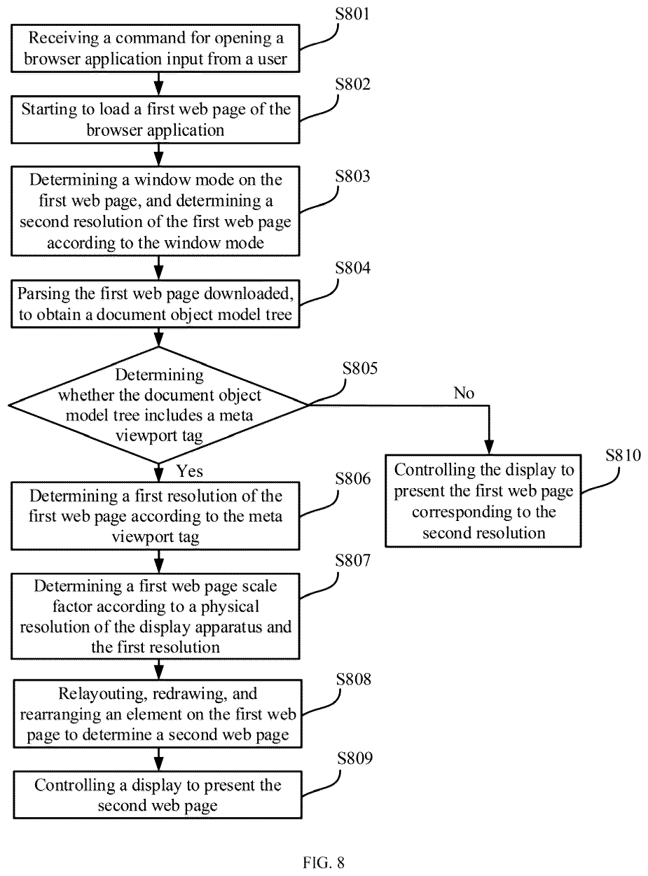

In view of the above issues, embodiments of the disclosure provide a display apparatus 200. The above embodiments may be referred to for the structure of the display apparatus 200 and functions of parts thereof. In addition, on the basis of the display apparatus 200 shown in the above embodiments, this embodiment further improves some functions of the display apparatus 200. As shown in FIG. 8, the processor 250 performs following steps.

Step S801: receiving a command for opening a browser application input from a user.

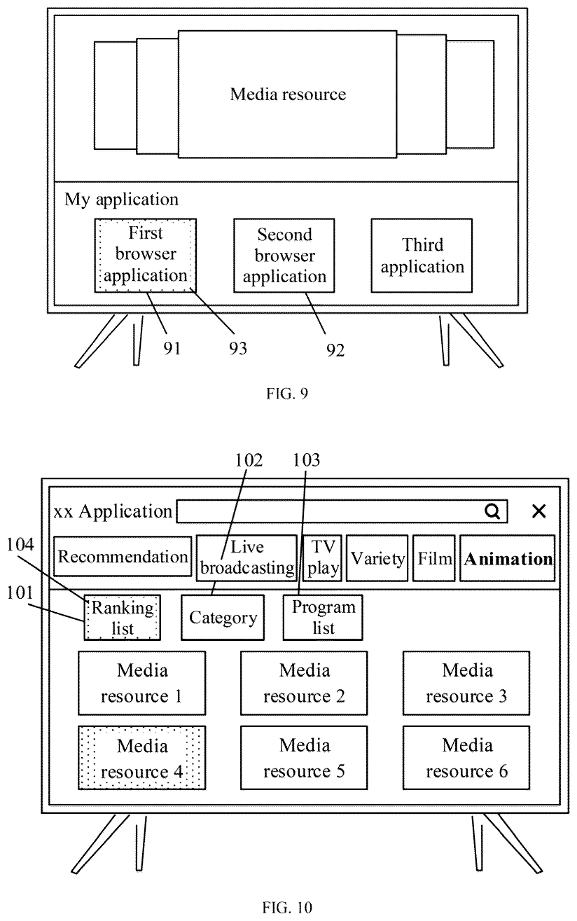

In some embodiments, the display 260 presents a home page, the home page includes a browser application control, wherein the browser application is an application developed based on browser technologies, and a user may input the command for opening the browser application through a confirmation operation on the browser application control. For example, the home page is shown in FIG. 9. FIG. 9 includes a first browser application control 91, a second browser application control 92, and a focus 93 for indicating that a control is selected, where the focus currently indicates that the first browser application control 91 is selected. When the user presses an OK button on the control device 100, the command for opening the browser application is input.

In some embodiments, the command for opening the browser application includes a command for opening a web page in the browser application. The display 260 presents a first page of a first browser application. The first page includes at least one page skip control. The page skip control is a control that cancels presenting the first page, and presents a second page. The user may input a command for opening the second page of the first browser application through a confirmation operation on the page skip control. For example, an animation recommendation page of the first browser application is shown in FIG. 10. FIG. 10 includes a ranking list control 101, a categorization control 102, a program list control 103, and a focus 104 for indicating that a control is selected, where the focus currently indicates that the ranking list control 101 is selected. When the user presses the OK button of the control device 100, a command for opening a ranking list page of the browser application is input.

It should be noted that the browser application refers to a browser-based application in the display apparatus. The browser application is opened essentially to present a browser page, and contents of the browser page are controlled by the browser application. The browser application includes an HbbTV application, a Store application, and an Open browser web page application.

Step S802: in response to the command for opening the browser application input from the user, starting to load a first web page of the browser application.

In some embodiments, a confirmation command of the user on the browser application control is received, and the browser application control is configured with a link, through which the first web page can be downloaded.

In some embodiments, a confirmation command for the page skip control of the browser application is received, and the page skip control is configured with a skip link, through which the second page of the browser application, i.e., the first web page, can be downloaded. The skip link can comprise an address for pointing to the second page of the browser application.

In some embodiments, the middleware layer shown in FIG. 4 includes a configuration layer configured to, in response to the command for opening the browser application input from the user, start to load the first web page of the browser application.

Step S803: determining a window mode on the first web page, and determining a second resolution of the first web page according to the window mode.

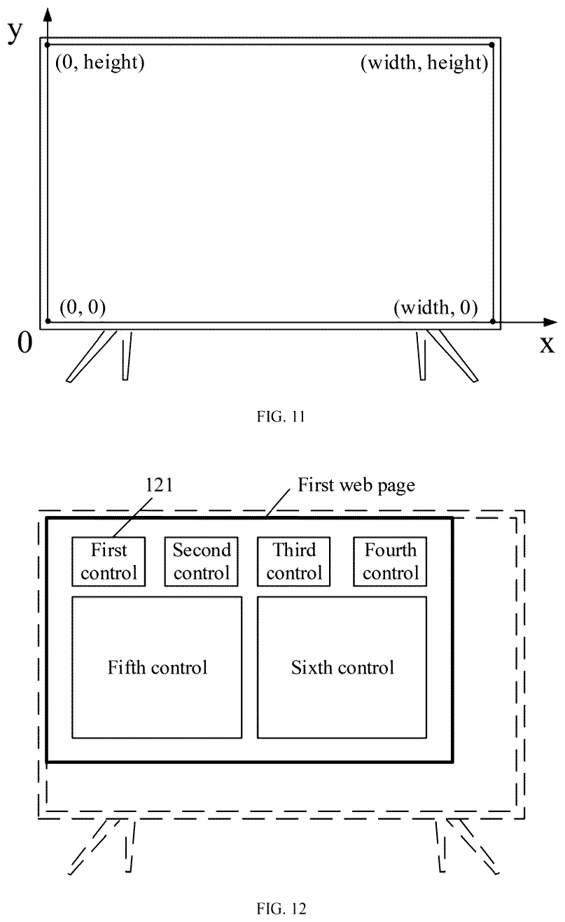

In some embodiments, in the browser, a window may be created for the to-be-loaded first web page before the first web page is loaded, and may be used as a rendering region for the first web page. The rendering region for the first web page is denoted as (x, y, width, height). Values of x and y are 0, the width is a width on the first web page, and the height is a height on the first web page. A rectangular coordinate system is established with two adjacent sides of the display screen as the x-axis and y-axis, and with an intersection of the two adjacent sides as the coordinate origin. The rendering region on the first web page (x, y, width, height) is a rectangular region enclosed by four vertexes (0, 0), (width, 0), (0, height), and (width, height), as shown in FIG. 11.

In some embodiments, a window mode (x, y, width, height) of the HbbTV application is (0, 0, 1280, 720). A window mode of the Store application is (0, 0, 1280, 720) or (0, 0, 1920, 1080). A window mode of the Open Browser application is (0, 0, 1920, 1080). A window mode for loading the current first web page is detected before the first web page is loaded.

In some embodiments, specific values of the window mode may be acquired directly from window mode parameters for the first web page.

In some embodiments, a name of a current browser application may be first determined, and then a window mode corresponding to the browser application may be determined based on the browser application.

In some embodiments, a width value and a height value in the window mode are the second resolution of the first web page, i.e., a second resolution of the window mode (x, y, width, height) is width*height. For example, a second resolution of the window mode (0, 0, 1280, 720) is 1280*720, and a second resolution of the window mode (0, 0, 1920, 1080) is 1920*1080.

In some embodiments, the configuration layer is further configured to determine the window mode on the first web page, and determine the second resolution of the first web page according to the window mode.

In some embodiments, the middleware layer shown in FIG. 4 includes an ability layer, and the configuration layer is further configured to send the second resolution of the first web page to the ability layer.

It should be noted that step S803 may be omitted if a document object model tree obtained by parsing the downloaded first web page includes a meta viewport tag, step S803 cannot be omitted if the document object model tree obtained by parsing the downloaded first web page does not include a meta viewport tag, but since the second resolution determined according to the window mode may not be adopted, the resolution of the first web page is determined by digits of the document object model tree.

Step S804: parsing the first web page downloaded, to obtain a document object model tree.

In some embodiments, the first web page downloaded through a browser downloading module is parsed to obtain the document object model (DOM) tree on the first web page. A document object model is a standard programming interface recommended by W3C to process extensible markup language. The document object model is a document model described in an object-oriented manner. The document object model defines objects required to represent and modify a document, behaviors and attributes of these objects, and a relationship between these objects. The document object model may be served as a tree representation of data and structure on a page, but the page may not be implemented by such a tree.

In some embodiments, the ability layer is configured to parse the first web page downloaded, to obtain the document object model tree.

Step S805: determining whether the document object model tree includes a meta viewport tag.

In some embodiments, the document object model tree includes at least one tag. Whether there is a meta viewport tag in the document object model tree may be determined by traversing tag names of the document object model tree, or whether there is a meta viewport tag in the document object model tree may be determined by traversing tag names of web page heads in the document object model tree. A meta viewport tag name is denoted as <meta viewport>. For example, the tag names of the web page heads in the document object model tree are traversed, if there is a meta viewport in the web page heads, the document object model tree is determined to have a meta viewport tag; and if there is no meta viewport in the web page heads, the document object model tree is determined to have no meta viewport tag.

If the document object model tree includes a meta viewport tag, a first resolution of the first web page is determined according to the meta viewport tag (step S806).

In some embodiments, after the document object model tree is determined to include a meta viewport tag, a content of the meta viewport tag is extracted, and the first resolution of the first web page may be determined from the content of the meta viewport tag.

In some embodiments, for a normalized web page, the content of the meta viewport tag only includes a width of the presented web page, or the content of the meta viewport tag only includes a height of the presented web page. The first resolution of the first web page may be determined according to a single height or a single width. For example, the content of the meta viewport tag is <meta name=“viewport” content=“width=1280, initial-scale=1, user-scalable=1”>. The width on the first web page is 1280, and the resolution of the first web page may be determined to be 1280*720. A normalized web page refers to a web page designed according to a display screen aspect ratio of 16:9, such as a web page with a resolution of 1280*720 and a web page width a resolution of 1920*1080.

In some embodiments, for a non-normalized web page, the content of the meta viewport tag includes a width of the presented web page and a height of the presented web page. For example, the content of the meta viewport tag is <meta name=“viewport” content=“width=1280, height=1280, initial-scale=1, user-scalable=1”>. The width on the first web page is 1280, the height on the first web page is 1280, and the resolution of the first web page may be determined to be 1280*1280. The non-normalized web page refers to a web page not designed according to a display screen aspect ratio of 16:9, such as a web page with a resolution of 1280*1280.

In some embodiments, the ability layer is configured to determine the first resolution on the first web page according to the meta viewport tag.

In some embodiments, the processor 250 may first determine whether the first resolution is same as the physical resolution of the display apparatus.

If the first resolution is same as the physical resolution of the display apparatus, the display is controlled to directly present the first web page corresponding to the first resolution.

If the second resolution is different from the physical resolution of the display apparatus, the processor 250 executes step S807: determining a first web page scale factor according to the physical resolution of the display apparatus and the first resolution.

In this embodiment, when the first resolution is same as the physical resolution of the display apparatus, it may not execute steps, such as determining the first web page scale factor, re-layouting, redrawing, and rearranging element(s) on the first web page, etc.

In some embodiments, the processor 250 determines the first web page scale factor according to the physical resolution of the display apparatus and the first resolution (step S807) without determining whether the first resolution is same as the physical resolution of the display apparatus.

In some embodiments, a memory physical resolution for a browser in the display apparatus is set as 1280*720 or 1920*1080.

In some embodiments, a memory physical resolution for a browser in the display apparatus is set as 1280*1280.

In some embodiments, the first web page scale factor has only one value, and may be determined based on a ratio of a physical horizontal resolution of the display apparatus to a first horizontal resolution, or a ratio of a physical longitudinal resolution of the display apparatus to a first longitudinal resolution.

In some embodiments, the first web page scale factor includes a width scale factor on the first web page and a height scale factor on the first web page. The width scale factor on the first web page is the ratio of the physical horizontal resolution of the display apparatus to the first horizontal resolution, and the height scale factor on the first web page is the ratio of the physical longitudinal resolution of the display apparatus to the first longitudinal resolution. The width scale factor on the first web page may be same as, or may be different from, the height scale factor on the first web page.

In some embodiments, a web page identifier is configured on the first web page or a web page tag is configured in the document object model tree. Whether the first web page is a normalized web page is determined according to a value of the web page identifier or the web page tag. If the value of the web page identifier or the web page tag is a first preset value, the first web page is determined to be a normalized web page. The first web page scale factor has only one value, and is the ratio of the physical horizontal resolution of the display apparatus to the first horizontal resolution, or is the ratio of the physical longitudinal resolution of the display apparatus to the first longitudinal resolution. If the value of the web page identifier or the web page tag is a second preset value, the first web page is determined to be a non-normalized web page. The first web page scale includes the width scale factor on the first web page and the height scale factor on the first web page. The width scale factor on the first web page is the ratio of the physical horizontal resolution of the display apparatus to the first horizontal resolution; and the height scale factor on the first web page is the ratio of the physical longitudinal resolution of the display apparatus to the first longitudinal resolution.

For example, the resolution of the first web page is 1280*720, and the physical resolution of the display apparatus is 1920*1080. If the value of the web page identifier or the web page tag is a first value, for example 1, the first web page is determined to be a normalized web page. The first web page scale factor (scale) is the ratio of the physical horizontal resolution of the display apparatus to the first horizontal resolution, i.e., scale=1920/1280=1.5.

For example, the resolution on the first web page is 1280*1280, and the physical resolution of the display apparatus is 1920*1080. If the value of the web page identifier or the web page tag is a second value, for example 0, the first web page is determined to be a non-normalized web page. The width scale factor (scale1) on the first web page is the ratio of the physical horizontal resolution of the display apparatus to the first horizontal resolution, i.e., scale1=1920/1280=1.5; and the height scale factor (scale2) on the first web page is the ratio of the physical longitudinal resolution of the display apparatus to the first longitudinal resolution, i.e., scale2=1080/1280=0.84.

In some embodiments, the ability layer is configured to determine the first web page scale according to the physical resolution of the display apparatus and the first resolution.

Step S808: relayouting, redrawing, and rearranging an element on the first web page based on the first web page scale factor to determine a second web page.

In some embodiments, the relayouting, redrawing, and rearranging an element on the first web page based on the first web page scale factor to determine the second web page includes: computing a coordinate of an element on the first web page based on the first web page scale factor to obtain a second coordinate; and rearranging the element on the first web page according to the second coordinate to obtain the second web page.

It should be noted that the method in embodiments is only applicable to a scenario where the first web page scale factor is greater than 1.

In some embodiments, the first web page includes at least one element corresponding to a control. The control includes a selectable control and a non-selectable control. The selectable control refers to a control which is able to receive a focus selection via a remote control, a voice command or other manners; and the non-selectable control refers to a control which is not able to receive a focus selection.

In some embodiments, the first web page scale factor has only one value. The rectangular coordinate system is established with two adjacent sides of the display screen as the x-axis and y-axis, and with an intersection of the two adjacent sides as the coordinate origin to determine a first coordinate (x1, y1) of a center point of the control on the first web page, and determine a second coordinate (x2, y2) of the center point of the control on the second web page according to the first coordinate (x1, y1) and the first web page scale factor (scale), where x2=x1*scale; and y2−y1*scale.

In some embodiments, the first web page scale factor includes a width scale factor on the first web page and a height scale factor on the first web page. The rectangular coordinate system is established with two adjacent sides of the display screen as the x-axis and y-axis, and with an intersection of the two adjacent sides as the coordinate origin, to determine the first coordinate (x1, y1) of the center point of the control on the first web page, and determine the second coordinate (x2, y2) of the center point of the control on the second web page according to the first coordinates (x1, y1), the width scale factor (scale1) on the first web page, and the height scale factor (scale2) on the first web page, where x2=x1*scale1; and y2=y1*scale2.

In some embodiments, the center point of the control may be replaced with four vertexes of the control.

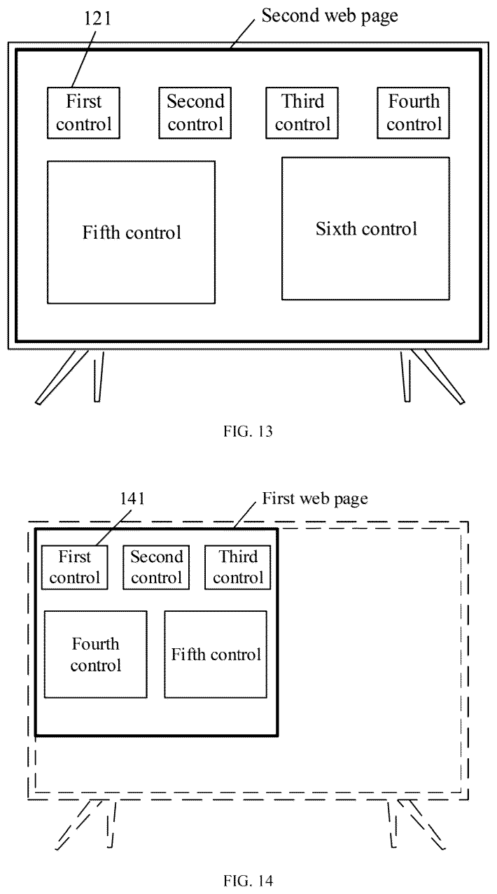

For example, a layout of controls on the first web page is shown in FIG. 12, the resolution of the first web page is 1280*720; the physical resolution of the display apparatus is 1920*1080, and the first web page scale factor is computed to be 1.5. For example, for a first control 121 in FIG. 12, a first coordinate (x1, y1) of a center point of the first control 121 is (100, 650), and a second coordinate (x2, y2) of the center point of the first control 121 is (150, 975), where x2-x1*scale=100*1.5=150; y2=y1*scale=650*1.5=975, and the first control 121 is presented with (150, 975) as the coordinate of the center point of the first control 121. After coordinate of center points of all controls on the first web page are computed to obtain the second coordinate, the controls are rearranged according to the second coordinate to obtain the second web page, as shown in FIG. 13.

For example, a layout of the controls on the first web page is shown in FIG. 14, the resolution on the first web page is 720*720; the physical resolution of the display apparatus is 1920*1080, the width scale factor (scale1) on the first web page is determined to be 2.7, and the height scale factor (scale2) on the first web page is determined to be 1.5. For example, for a first control 141 in FIG. 14, first coordinate (x1, y1) of a center point of the first control 141 is (100, 600), and second coordinate (x2, y2) of the center point of the first control 141 is (270, 900), where x2=x1*scale1=100*2.7=270; y2=y1*scale2=600*1.5=900, and the first control 141 is presented with (270, 900) as the coordinate of the center point of the first control 141. After coordinates of center points of all controls on the first web page are determined to obtain the second coordinates, the controls are rearranged according to the second coordinates to obtain the second web page, as shown in FIG. 15.

In an embodiment of the disclosure, only the coordinates of the controls on the first web page are relayouted, such that the controls on the first web page are uniformly distributed on the display screen, the computing method is simple, and after a command for opening a browser application from the user is received, the second page can be presented faster.

In some embodiments, if a control corresponding to an element on the first web page is a text control, a coordinate of the element on the first web page is computed according to the first web page scale factor to obtain second coordinate, and the text control may be directly stretched or compressed according to the first web page scale factor. For example, the first web page scale factor is 1.5, and the text control may be stretched by 1.5 times as much as the width and the height on the first web page. The stretched text control is presented at an area determined based on the second coordinate.

In some embodiments, if a control corresponding to an element on the first web page is an image control, a coordinate of the element on the first web page is computed according to the first web page scale factor to obtain second coordinate, and the image control may be directly stretched or compressed according to the first web page scale factor. For example, the first web page scale factor is 1.5, and the image control may be stretched by 1.5 times as much as the width and the height. The stretched image control is presented at an area determined according to the second coordinate.

In an embodiment of the disclosure, only the coordinates of the controls on the first web page are relayouted, such that the controls on the first web page are uniformly distributed on the display screen, the controls corresponding to elements are stretched or compressed, the computing method is simple, the controls can be better arranged on the screen, and after the command for opening a browser application sent from the user is received, the second page can be presented faster.

In some embodiments, the relayouting, redrawing, and rearranging the elements on the first web page based on the first web page scale factor to determine the second web page includes: computing a coordinate of the element on the first web page based on the first web page scale factor to obtain a second coordinate; and computing a size of the element on the first web page based on the first web page scale factor to obtain a second size of the element on the second web page.

The size of the element refers to a size of the element presented on the web page. If a control corresponding to the element is a picture control, a size of the picture control is a width and a height of a picture; if a control corresponding to the element is a text control, the text control corresponds to a font size of a text; and if a control corresponding to the element is a composite control, the composite control refers to a control including at least two controls that can be selected simultaneously. The composite control can be split into two sub-controls, and sizes of the two sub-controls can be computed respectively. For example, the composite control includes a picture control and a text control arranged at the bottom of the picture control, a width and a height of the picture control may be computed respectively, and a font size of the text control may be computed.

The element on the first web page is rearranged according to the second coordinate, and the element of the second size is drawn at a position of the second coordinate to obtain the second web page.

In some embodiments, if a control corresponding to an element on the first web page is a text control, a first coordinate (x1, y1) of a specific point of the text control and a first font size A1 of a text in the text control are determined, where the specific point includes a center point or a vertex of the text control.

A second coordinate (x2, y2) of the specific point of the text control is determined according to the first coordinate (x1, y1) of the specific point of the text control and the first web page scale factor (scale); where x2=x1*scale; and y2=y1*scale.

A second font size (A2) of the text is determined according to the first font size (A1) of the text and the first web page scale factor (scale); where A2−A1*scale.

In some embodiments, in order to avoid excessive enlargement of the font of the text, a corresponding font scale factor can be set for the first web page scale factor, and then the font size can be changed according to the font scale factor. For example, when the first web page scale factor is 1.5, the font enlargement factor is 1.2.

In some embodiments, the first web page scale factor includes a width scale factor (scale1) on the first web page and a height scale factor (scale2) on the first web page, and the second font size of the text is A2−A1*scale1 or A2−A1*scale2, or the second font size of the text is computed by selecting a minimum value of the width scale factor (scale1) on the first web page and the height scale factor (scale2) on the first web page.

The text control is drawn at the position of the second coordinate, where a size of the text in the text control is the second font size.

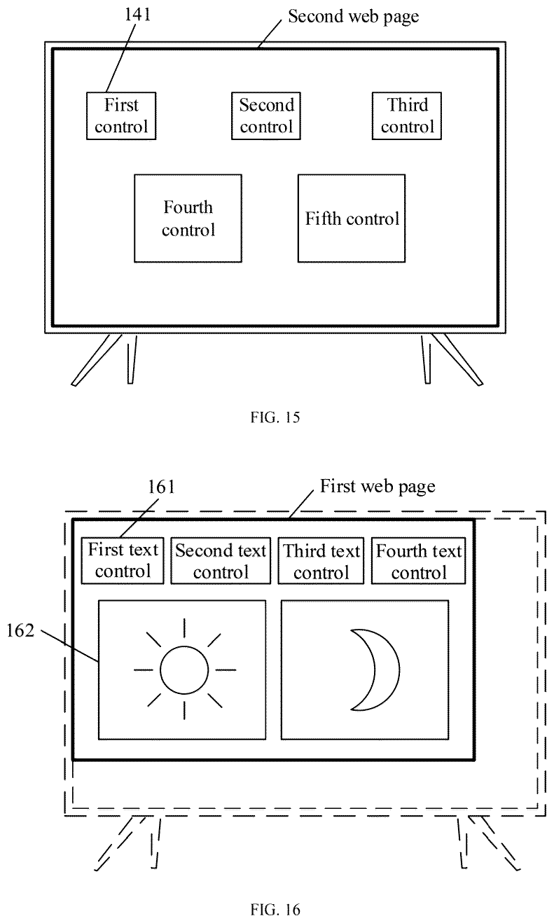

For example, a layout of controls on the first web page is shown in FIG. 16, the resolution of the first web page is 1280*720, the physical resolution of the display apparatus is 1920*1080, and the first web page scale factor is computed to be 1.5. For example, for a first text control 161 in FIG. 16, a first coordinate (x1, y1) of a center point of the first text control is (100, 650), and a second coordinate (x2, y2) of the center point of the first text control is (150, 975), where x2=x1*scale=100*1.5=150, and y2=y1*scale=650*1.5=975; a first font size of a text of the first text control 161 is 10, and a second font size of the text on the first text control 161 is 15; where A2−A1*scale=10*1.5=15. The first text control 161 with a font size of 15 is presented with (150, 975) as a coordinate of the center point of the first text control 161. Coordinates of center points and font sizes of texts of all text controls on the first web page are computed to obtain the second coordinates and second font sizes, the text controls are redrawn and rearranged according to the second coordinates and the second font sizes to obtain the second web page, as shown in FIG. 17.

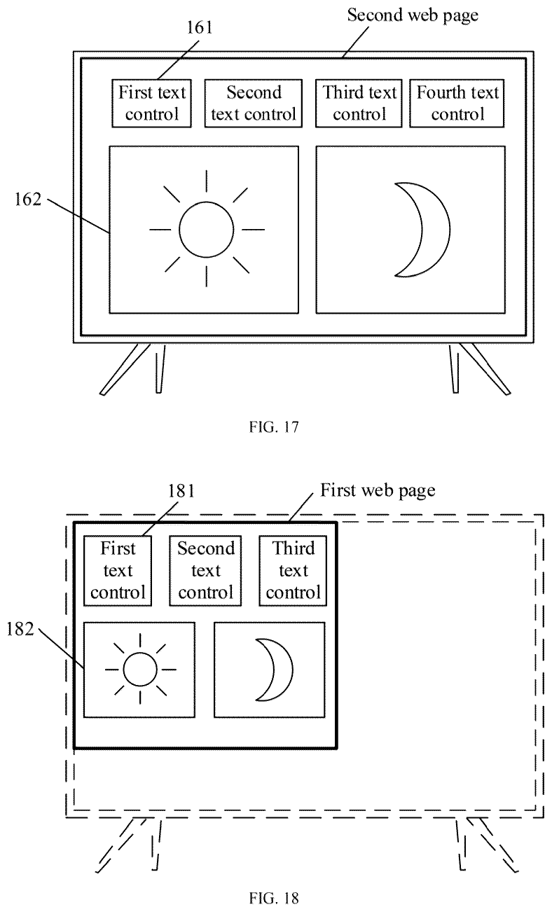

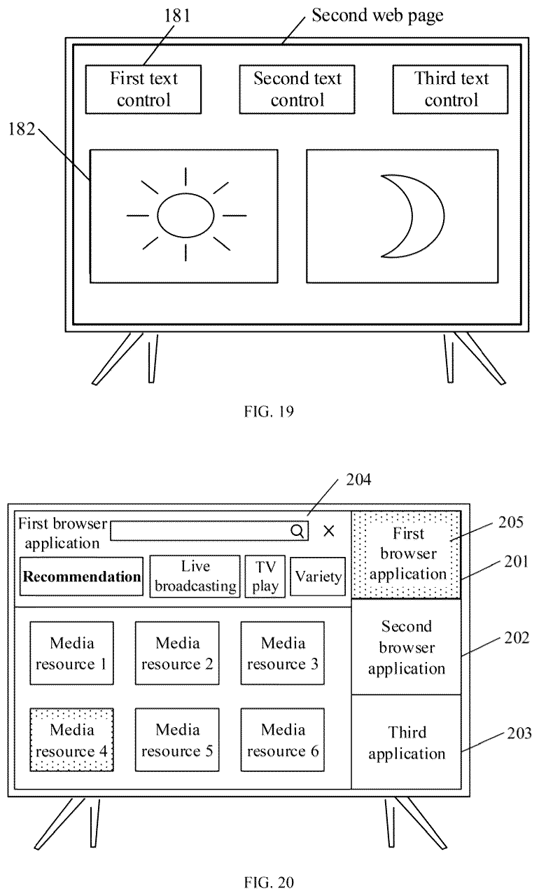

For example, a layout of the controls on the first web page is shown in FIG. 18, the physical resolution of the display apparatus is 1920*1080, the resolution of the first web page is 720*720; the width scale factor (scale1) on the first web page is computed to be 2.7, and the height scale factor (scale2) on the first web page is computed to be 1.5. For example, for a first text control 181 in FIG. 18, a first coordinate (x1, y1) of a center point of the first text control is (100, 650), and a second coordinate (x2, y2) of the center point of the first text control 181 is (150, 975), where x2=x1*scale=100*2.7=270, and y2=y1*scale=650*1.5=975; a first font size of a text of the first text control 181 is 10, and a second font size of the text of the first text control is 15; where A2=A1*scale=10*1.5=15. The first text control 181 with a font size of 15 is presented with (270, 975) as a coordinate of the center point of the first text control 181. After coordinates of center points and font sizes of texts of all text controls on the first web page are computed to obtain the second coordinates and the second font sizes, the text controls are redrawn and rearranged according to the second coordinates and the second font sizes to obtain the second web page, as shown in FIG. 19.

In some embodiments, if a control corresponding to an element on the first web page is an image control, a first coordinate of a specific point of the image control, a first width of the image control, and a first height of the image control are determined, where the specific point includes a center point or a vertex of the image control.

A second coordinate (x2, y2) of the specific point of the image control is determined according to the first coordinate (x1, y1) of the specific point of the image control and the first web page scale factor (scale), where x2=x1*scale; and y2=y1*scale.

A second width (W2) and a second height (H2) of the image control are determined according to the first width (W1) and the first height (H1) of the image control and the first web page scale factor (scale); where W2=W1*scale, and H2=H1*scale.

In some embodiments, the first web page scale factor includes a width scale factor (scale1) on the first web page and a height scale factor (scale2) on the first web page, the second width of the image control is W2=W1*scale1, and the second height of the image control is H2=H1*scale2.

In some embodiments, in order to avoid inconsistency in scaling with respect to length-to-width ratio of an image, when the first web page scale factor includes the width scale factor (scale1) for the first web page and the height scale factor (scale2) for the first web page, width and height computation may be performed by selecting a smaller one of the two. For example, scale1<scale2, the second width of the image control is W2=W1*scale1, and the second height of the image control is H2=H1*scale1.

The image control is drawn according to the second coordinate of the specific point of the image control, a width of the image control is the second width, and a height of the image control is the second height.

It should be noted that in the image control with the second width and the second height drawn according to the second coordinate, the image control is not directly stretched or compressed, but is redrawn according to the first web page scale factor.

The redrawing of the image control includes: recognizing a color of each pixel in the image, determining at least one pixel block, wherein colors of pixels within a pixel block are identical; determining a second region for the pixel block according to a first region for the pixel block and the first web page scale factor, and setting pixels in the second region as red pixels. Boundary lengths of the original pixel block may be multiplied by the first web page scale factor to determine the second region for the pixel block. The boundary length refers to a straight line at an edge of the pixel block, and is a closed graph enclosed by several boundaries. For example, for a rectangular red pixel block of 4*2, the first web page scale factor is 1.5, and a second region for the red pixel block is a rectangle of 6*3. A specific position where the red pixel block is presented may be determined based on a relative position between the red pixel block and the specific point of the image control, or based on actual coordinates of the red pixel block in the coordinate system.

For example, a layout of controls on the first web page is shown in FIG. 16, the resolution of the first web page is 1280*720, the physical resolution of the display apparatus is 1920*1080, and the first web page scale factor is computed to be 1.5. For example, for a first image control 162 in FIG. 16, a first coordinate (x1, y1) of an upper left vertex of the first image control 162 is (100, 500), and a second coordinate (x2, y2) of the upper left vertex of the first image control 162 is (150, 750), where x2=x1*scale=100*1.5=150, and y2=y1*scale=500*1.5=750; a first width of the first image control is 400, a first height of the first image control is 400, a second width of the first image control is 600, and a second height of the first image control is 600. The first image control 162 with a width of 600 and a height of 600 is presented with (150, 750) as coordinate of the upper left vertex of the first image control 162. After coordinates of upper left vertexes, widths, and heights of all image controls on the first web page are computed to obtain the second coordinates, second widths, and second heights, the image controls are redrawn and rearranged according to the second coordinates, the second widths, and the second heights to obtain the second web page, as shown in FIG. 17.

For example, a layout of the controls on the first web page is shown in FIG. 18, the resolution of the first web page is 720*720; the physical resolution of the display apparatus is 1920*1080; the width scale factor (scale1) of the first web page is computed to be 2.7, and the height scale factor (scale2) of the first web page is computed to be 1.5. For example, for a first image control 182 in FIG. 18, a first coordinate (x1, y1) of an upper left vertex of the first image control is (100, 500), and a second coordinate (x2, y2) of the upper left vertex of the first image control is (270, 750), where x2=x1*scale=100*2.7=270, and y2=y1*scale=500*1.5=750; a first width of the first image control is 200, a first height of the first image control is 200, a second width of the first image control is 540, and a second height of the first image control is 300. The first image control 182 with a width of 540 and a height of 300 is presented with (270, 750) as coordinate of the upper left vertex of the first image control 182. After coordinates of upper left vertexes, widths, and heights of all image controls on the first web page are computed to obtain the second coordinates, the second widths, and the second heights, the image controls are redrawn and rearranged according to the second coordinates, the second widths, and the second heights to obtain the second web page, as shown in FIG. 19.

These embodiments prevent occurrence of rendering a web page content in a small region of the screen or presenting a part of the web page content on the full screen, shows the user with an appropriate viewport and a clear page, and improves the image display quality.

Step S809: controlling the display to present the second web page.

If the document object model tree includes no meta viewport tag, the processor 250 executes step S810: controlling the display to present the first web page corresponding to the second resolution.

In some embodiments, if the document object model tree includes no meta viewport tag, the processor 250 may further determine a second web page scale factor according to the physical resolution of the display apparatus and the second resolution; relayout, redraw, and rearrange the element on the first web page based on the second web page scale factor to obtain a third web page; and control the display to present the third web page.

The computing method of the second web page scale factor is similar to that of the first web page scale factor, and the determination method of the third web page is similar to that of the second web page, which will not be repeated here.

Resolutions of different web pages in a same browser application may be different, and in the process of switching web pages in the same browser application, a phenomenon of screen flicker may arise. Embodiments of the disclosure can dynamically detect the web page rendering mode, i.e., the first resolution of the web page, and relayout, redraw, and rearrange the web page according to the first resolution and the physical resolution of the display apparatus, such that when a resolution of the switched web page is different from that of the current web page, the switched web page can still adapt to the physical resolution of the display apparatus, and an appropriate viewport can be presented to the user in the process of switching web pages.

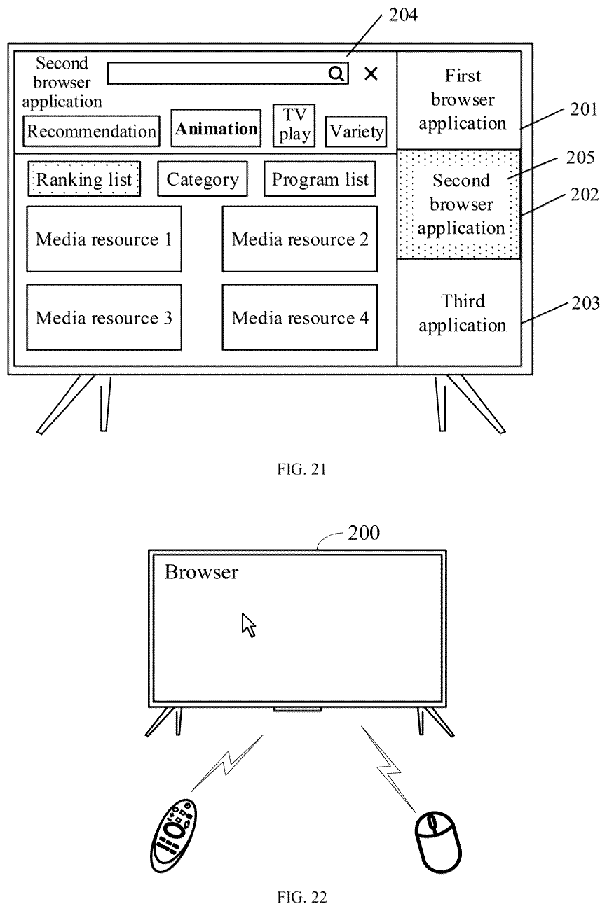

In some embodiments, when the user presses a button on the control device 100, all currently opened applications can be presented, including at least two browser applications. After a command for switching an application from the user is received, a focus moves from the first browser application control to a second browser application control, presenting a page of the first browser application is canceled, and a page of the second browser application is presented instead. For example, when the user presses a button on the control device 100, a user interface shown in FIG. 20 is presented. FIG. 20 includes a first browser application control 201, a second browser application control 202, a third application control 203, an application page display region 204, and a focus 205. The current focus indicates that the first browser application control 201 is selected, and a page corresponding to the first browser application control 201 is shown in the application page display region 204. When the user presses a down button on the control device 100, the focus 205 indicates that the second browser application control 202 is selected. In this case, the page of the second browser application is loaded, and is presented in the application page display region 204, as shown in FIG. 21. Embodiments of the disclosure can dynamically detect the web page rendering mode, i.e., the first resolution of the web page, and relayout, redraw, and rearrange the web page according to the first resolution and the physical resolution of the display apparatus, such that when a browser application with a different resolution is switched to, the switched browser application can still adapt to the physical resolution of the display apparatus, and an appropriate viewport can be presented to the user in the process of switching browser applications without occurrence of screen flicker.

Some embodiments of the disclosure provide a method for presenting a web page. The method is adapted to a display apparatus. The display apparatus includes a display and a processor. The at least one processor is further configured to execute instructions to cause the display apparatus to: in response to a command for opening a browser application input from a user, start to load a first web page of the browser application; parse the first web page downloaded, to obtain a document object model tree; in response to the document object model tree including a meta viewport tag, determine a first resolution of the first web page according to the meta viewport tag; determine a first web page scale factor according to a physical resolution of the display apparatus and the first resolution; relayout, redraw, and rearrange an element on the first web page based on the first web page scale factor to determine a second web page; and control the display to present the second web page. Some embodiments of the disclosure can prevent occurrence of screen flicker, rendering a web page content in a small region of the screen, or presenting a part of the web page content on the full screen, show the user with an appropriate viewport, achieve clearer web page display.

When the user controls use of a browser of the display apparatus 200 via a control device 100, a focus corresponding to the control device 100 is presented on a user interface of the browser. The focus is a virtual image of the control device 100 on the user interface, to visually show various commands sent from the user to the display apparatus 200 through the control device 100. For example, the control device 100 is a remote control, and the user issues a focus move command to the display apparatus 200 by operating the “up,” “down,” “left,” and “right” buttons on the remote control. In response to a focus move command, the display apparatus 200 moves the focus in a direction indicated by the focus move command on the user interface of the browser. For example, when the focus move command indicates to move upward, the display apparatus moves the focus upward on the user interface of the browser. Alternatively, the user issues a command to the display apparatus 200 by operating the “OK” button on the remote control, to instruct the display apparatus 200 to execute a corresponding task at a current position of the focus. In response to this command, the display apparatus 200 recognizes the current position of the focus. For example, if the focus is on a setting option, the command instructs the display apparatus 200 to execute a task corresponding to the setting option, i.e., presenting the setting menu.

In order to adapt to many functions offered by the browser, the browser provides a multi-device control function, i.e., the browser can respond to commands from multiple control devices 100. The display apparatus 200 may be connected with a plurality of control devices 100 simultaneously. As shown in FIG. 22, the display apparatus 200 is connected with two control devices 100 simultaneously, namely a remote control (on the left side of FIG. 22) and a mouse (on the right side of FIG. 22). However, the existing display apparatus 200 only presents one focus on the user interface of the browser for the multiple simultaneously connected control devices 100. As shown in FIG. 22, an “arrow” focus is presented for the two control devices 200 correspondingly, i.e., no matter the display apparatus 200 receives a command sent from whichever control device 100, the display apparatus shows a response to the command through a focus 501, i.e., when the display apparatus 200 responds to the command sent from the control device 100, there is many-to-one corresponding relationship between the control devices 100 and the focus. For example, in response to a focus move command sent from the user through the remote control, the display apparatus 200 moves the focus from a position A to a position B; in response to a focus move command sent from the user through the mouse, the display apparatus 200 moves the focus from the position B to a position C; and in response to a focus move command sent from the user through the remote control, the display apparatus 200 moves the focus from the position C to a position D. As can be seen, in response to whichever control device 100, the display apparatus 200 presents a same focus. Only based on a focus move change, it is difficult to distinguish a focus move command sent from whichever control device 100 corresponding to this focus move change, and the multiple control devices 100 also send commands to the display apparatus 200 non-simultaneously. Therefore, based on one focus, it is difficult to separate the control of different control devices 100, i.e., based on one focus, it is difficult for the multiple control devices 100 to simultaneously control the display apparatus in using the browser.

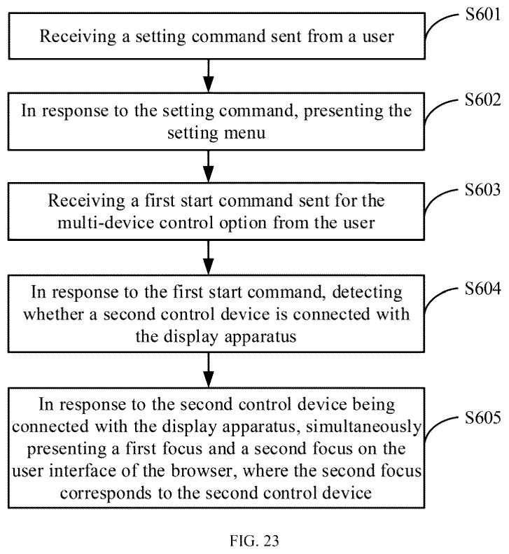

In order to simultaneously control operations in using the browser by the multiple control devices 100, further embodiments of the disclosure provide a display apparatus and a control method for multiple devices based on multiple focuses, for which the processes shown in FIG. 23 may be referred to. The specific steps are discussed as follows.

S601: receiving a setting command sent from a user, where the setting command is used for instructing to present a setting menu.

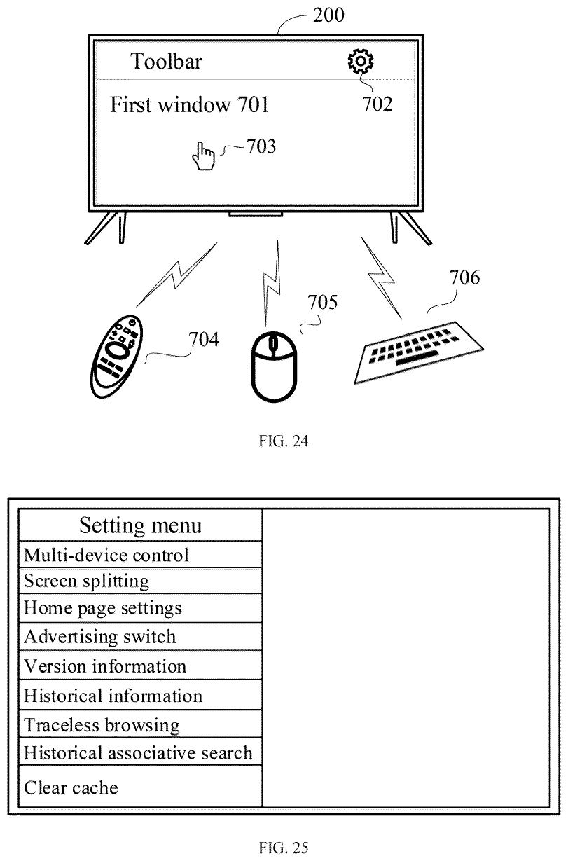

As shown in FIG. 24, the display apparatus 200 is currently connected with a first control device 704, such as a remote control. The display apparatus 200 currently presents a user interface of a browser. The user interface of the browser includes a first window 701 and a toolbar, where contents presented in the first window 701 change flexibly based on a network resource, contents presented in the toolbar include various functional options, which are associated with a configuration of the display apparatus 200 and user settings, and the contents presented in the toolbar are relatively constant. A plurality of styles of relative position between the first window 701 and the toolbar may be presented based on the configuration of the display apparatus 200 and the user settings. For example, as shown in FIG. 24, the toolbar 702 is located above the first window 701, or the toolbar may be located on the left side of, on the right side of, or below the first window 701, which will not be repeated here.

As shown in FIG. 24, a first focus 703 is also presented in the user interface of the browser. The first focus 703 corresponds to the first control device 704, i.e., the first focus 703 is used for showing a response result of the display apparatus 200 to a command sent from the first control device.

The user issues a setting command to the display apparatus 200 through the first control device 704 to instruct the display apparatus 200 to present the setting menu. For example, the first control device 704 is a remote control. The user sends a focus move command to the display apparatus 200 by operating the “up,” “down,” “left,” and “right” buttons on the remote control. In response to the focus move command, the display apparatus 200 presents the first focus 703 at a position after movement, until the first focus 703 moves to the setting option 702 in the toolbar. The user sends a confirmation command to the display apparatus 200 by pressing the “OK” button of the remote control. In response to the confirmation command, the display apparatus 200 recognizes position coordinates of the first focus 703, i.e., the position coordinates of the first focus 703 correspond to the setting option 702, such that the confirmation command is determined to correspond to the setting command, and is used for instructing to present the setting menu.

S602: in response to the setting command, presenting the setting menu.

In response to the setting command, the display apparatus 200 presents the setting menu on the user interface of the browser. As shown in FIG. 25, the setting menu includes a multi-device control option. The multi-device control option includes two states, namely an on state and an off state, where the off state means that the display apparatus 200 only supports a single device control, i.e., the display apparatus 200 is simultaneously connected with the multiple control devices 100, and only presents the same focus on the user interface of the browser correspondingly, as shown in FIG. 22, which will not be repeated here. The on state means that the display apparatus 200 supports simultaneously controlling of the display apparatus 200 by multiple control devices 100, i.e., if the display apparatus 200 is currently connected with multiple control devices 100, the multiple control devices 100 has their respective corresponding focuses on the user interface of the browser, i.e., the multiple focuses is simultaneously presented on the user interface of the browser, where each focus corresponds to one of the control devices 100, and different focuses correspond to different control devices 100. In this case, each focus shows a response result of the display apparatus 200 to a command sent from a corresponding control device 100.

S603: receiving a first start command for the multi-device control option from the user, where the first start command is used for instructing to start a function of simultaneously controlling focuses by multiple control devices.

The first start command to the display apparatus 200 is input by operating the first control device 704, to adjust the multi-device control option state to the on state. For example, the first control device 704 is still a remote control. The user issues a focus move command to the display apparatus 200 by operating the remote control, to move the first focus 703 to the multi-device control option. The user sends a confirmation command to the display apparatus 200 by pressing the “OK” button on the remote control. In response to the confirmation command, the display apparatus 200 recognizes current position coordinates of the first focus 703, i.e., the position coordinates of the first focus 703 correspond to the multi-device control option, and the current state is the off state, such that the confirmation command is determined to correspond to the first start command, and is used for instructing to switch the multi-device control option state to the on state.

S604: in response to the first start command, detecting whether a second control device is connected with the display apparatus.

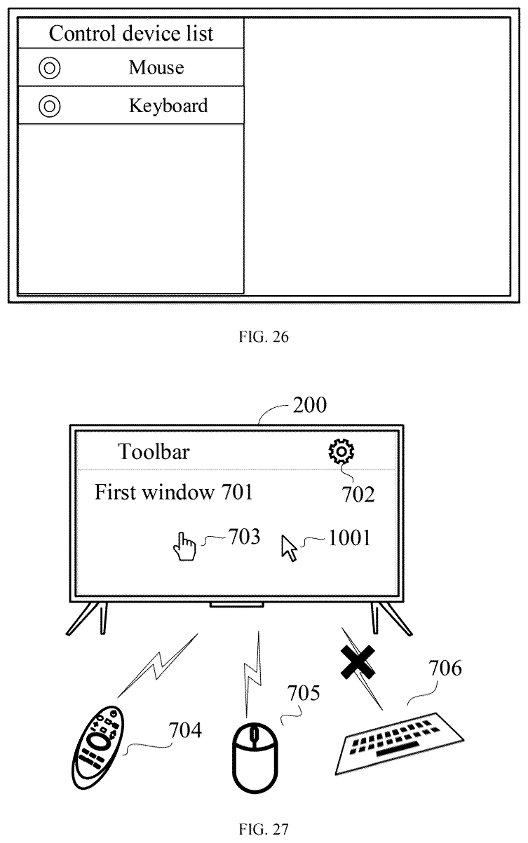

The display apparatus 200 forwards the first start command from the browser to an underlying browser (such as Odin browser), and the underlying browser detects whether the display apparatus 200 is currently connected with other control device, where there is a bidirectional communication function between the underlying browser and the browser. In some embodiments, the underlying browser determines whether there is a control device other than the first control device 704 by detecting connection information of the control device 100, such as interface state information, etc. If there is other control device, device information of each control device is acquired, a control device list is generated based on such device information, and the underlying browser sends the control device list to the browser to present the control device list on the user interface of the browser. The device information of a control device includes information which is used to identify the control device, such as device name, device identifier, etc., and correspondingly, the control device list includes various control device options, where corresponding device information is marked on the control device options. The underlying browser detects that the display apparatus 200 is connected with other control device, as shown in FIG. 24, a control device A705 and a control device B706, where the control device A705 is a mouse, and the control device B706 is a keyboard, device information of the control device A705 is acquired as “mouse,” and device information of the control device B706 is acquired as “keyboard.” The underlying browser generates a control device list based on the device information “mouse” and “keyboard.” As shown in FIG. 26, the control device list includes an option “mouse” for the control device A705 and an option “keyboard” for the control device B706. The control device list may further include an option of the first control device 704, such as “remote control,” with a mark provided on the option of the first control device 704, to indicate that the control device is the first control device 704 corresponding to the currently presented first focus 703. The underlying browser sends the generated control device list to the browser for display.

By browsing the control device list, the user can quickly and accurately know control devices currently in connection with the display apparatus 200, and select a control device to be used therefrom, i.e., the second control device. The second control device may be one control device from the control device list, or may be multiple control devices in the control device list.

For a first example, the user selects a control device based on the control device list shown in FIG. 26. For example, the first control device 704 is still a remote control. The user sends a focus move command to the display apparatus 200 by operating the remote control, to move the first focus 703 to an option of the second control device, such as the option “mouse.” The user sends a confirmation command to the display apparatus 200 by pressing the “OK” button of the remote control. In response to the confirmation command, the display apparatus 200 recognizes current position coordinates of the first focus 703, i.e., the position coordinates of the first focus 703 for the option “mouse,” such that the confirmation command is determined to select the “mouse” for use.

For a second example, the user selects a control device based on the control device list shown in FIG. 26. For example, the first control device 704 is still a remote control. According to the processes in the first example, the “mouse” is selected for use as the second control device. Further, referring to the processes in the first example, the “keyboard” is also selected for use as the second control device. In this case, there are multiple second control devices, i.e., both the “mouse” and the “keyboard” are the second control devices, and simultaneously control the display apparatus 200 together with the first control device 704.

For a third example, the user selects a control device based on the control device list shown in FIG. 26. For example, the first control device 704 is still a remote control. Different from the second example, the user sends a focus move command to the display apparatus 200 by operating the remote control, to move the first focus 703 to an option of the first control device 704, and sends a confirmation command to the display apparatus 200 by pressing the “OK” button on the remote control. In response to the confirmation command, the display apparatus 200 recognizes current position coordinates of the first focus 703, i.e., the option of the first control device 704, recognizes that the option of the first control device 704 is currently in a selected state, meaning the first control device serves as a control device of the display apparatus, and determines that the confirmation command is a command for instructing deactivating selection of the first control device 704. In response to the confirmation command, the display apparatus 200 does not select the first control device 704, so that the display apparatus 200 is not controlled by the first control device 704, and only the second control device is involved in the multi-device control.

S605: in response to the second control device being connected with the display apparatus, simultaneously presenting the first focus and a second focus on the user interface of the browser, where the second focus corresponds to the second control device.

In response to a command for instructing to select the second control device, the display apparatus 200 simultaneously presents the first focus 703 and the second focus on the user interface of the browser, where the second focus corresponds to the second control device.

For a fourth example, corresponding to the first example, the user only selects one second control device, namely the control device A705. In this case, the first control device 704 and the control device A705 simultaneously control the display apparatus 200. In order to simultaneously control the display apparatus 200 by two control devices, focuses of the two control devices are presented separately. As shown in FIG. 27, a new focus, namely a focus A1001, i.e., the second focus, is added on the user interface of the browser. The focus A1001 corresponds to a control device A, and is used for showing a response result of the display apparatus 200 as a reply to a command sent from the control device A. Therefore, a control operation for the display apparatus 200 based on the first control device 704 can be shown through the first focus 703 alone, and a control operation for the display apparatus 200 based on the control device A705 can be shown through the focus A1001 alone. Since the first focus 703 and the focus A1001 are separated from each other, the control operation of the user on the display apparatus 200 based on the first control device 704 and the control operation for the display apparatus 200 based on the control device A705 have no influence on each other, i.e., the user can simultaneously control use of the browser on the display apparatus 200 based on the first control device 704 and the control device A705.

In this example, other connected control device, such as the control device B706 (shown by dotted lines), is prohibited from controlling the display apparatus 200.

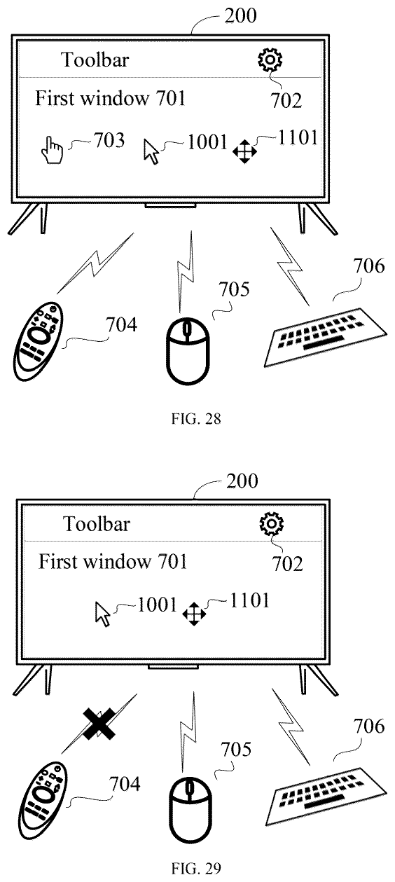

For a fifth example, corresponding to the second example, the user selects multiple second control devices, namely the control device A705 and the control device B706. In this case, as shown in FIG. 28, the first control device 704, the control device A705, and the control device B706 simultaneously control the display apparatus 200. In order to simultaneously control the display apparatus 200 by three control devices, focuses of the three control devices are presented separately, i.e., two new focuses, namely a focus A1001 and a focus B1101 (both the focus A1001 and the focus B1101 are second focuses), are added on the user interface of the browser. The focus A1001 corresponds to the control device A705, and is used for showing a response result of the display apparatus 200 to a command sent from the control device A705. The focus B1101 corresponds to the control device B706, and is used for showing a response result of the display apparatus 200 to a command sent from the control device B706. Therefore, a control operation of the user on the display apparatus 200 based on the first control device 704 can be shown through the first focus 703 alone, a control operation for the display apparatus 200 based on the control device A705 can be shown through the focus A1001 alone, and a control operation for the display apparatus 200 based on the control device B706 can be shown through the focus B1101 alone. Since the first focus 703, the focus A1001, and the focus B1101 are separated from each other, the control operation for the display apparatus 200 based on the first control device 704, the control operation for the display apparatus 200 based on the control device A705, and the control operation for the display apparatus 200 based on the control device B706 have no influence on each other, i.e., the user can simultaneously control the display apparatus 200 based on the first control device 704, the control device A705, and the control device B706.

In this example, if there are other control devices that are not selected as the second control device, these control devices are prohibited from controlling the display apparatus 200.

For a sixth example, corresponding to the third example, the user selects multiple second control devices, namely the control device A705 and the control device B706, but deletes the control by the first control device 704. In this case, as shown in FIG. 29, the control device A705 and the control device B706 simultaneously control the display apparatus 200. In order to simultaneously control the display apparatus 200 by two control devices, focuses of the two control devices are presented separately, i.e., two new focuses, namely the focus A1001 and the focus B1101 (both the focus A1001 and the focus B1101 are second focuses), are added on the user interface of the browser. The focus A1001 corresponds to the control device A705, and is used for showing a response result of the display apparatus 200 to a command sent from the control device A705. The focus B1101 corresponds to the control device B706, and is used for showing a response result of the display apparatus 200 to a command sent from the control device B706. In this case, the first focus 703 is deleted. Therefore, a control operation for the display apparatus 200 based on the control device A705 can be shown through the focus A1001 alone, and a control operation for the display apparatus 200 based on the control device B706 can be shown through the focus B1101 alone. Since the focus A1001 and the focus B1101 are separated from each other, the control operation for the display apparatus 200 based on the control device A705 and the control operation for the display apparatus 200 based on the control device B706 have no influence on each other, i.e., the user can simultaneously control the display apparatus 200 based on the control device A705 and the control device B706. In this example, not only can multiple new control devices be used to control the display apparatus 200 in place of the original control device, but also the multiple new control devices can simultaneously control the display apparatus 200.

In this example, if there are other control devices that are not selected as the second control device, these control devices and the first control device 704 are prohibited from controlling the display apparatus 200.

In some embodiments, the user can flexibly adjust the control devices 100 involved in the multi-device control. The user sends a command to the display apparatus 200 by operating the currently used first control device 704 or second control device, to instruct the display apparatus to present the control device list, and select a control device to be added to or to be deleted from the control device list.

In some embodiments, in order to facilitate distinguishing between corresponding control devices through focuses, the focuses are set to different styles, i.e., the first focus 703 and the second focus are different in style, and the second focuses are also different in style. The focuses can be distinguished by a simple pointer style, as shown in FIG. 27, FIG. 28, and FIG. 29, where “hand” represents a focus of the remote control, “arrow” represents a focus of the mouse, and “crossed arrow” represents a focus of the keyboard. Therefore, the user can quickly determine an accurate position of a focus corresponding to each control device on the user interface of the browser according to the focus style without operating each control device one by one, to determine the focus corresponding to the control device.

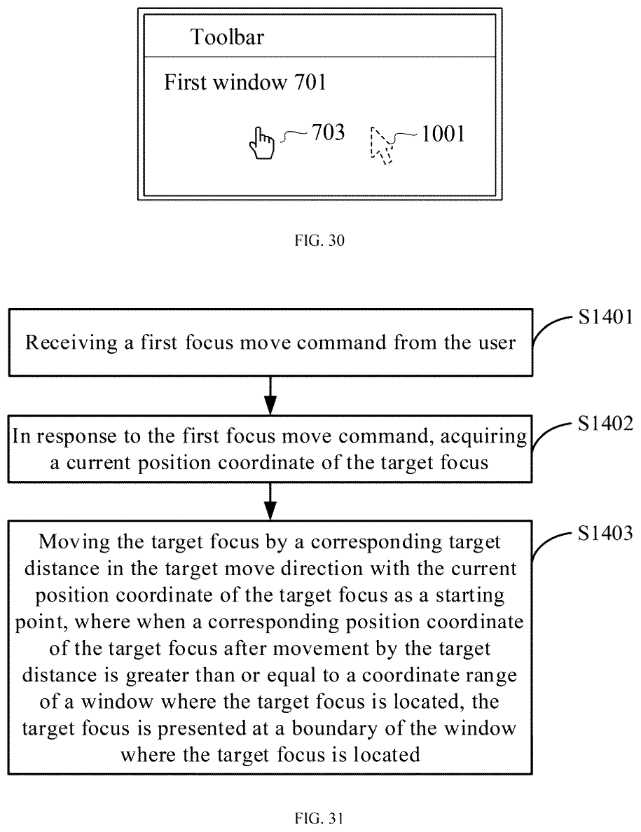

In some embodiments, when the user currently controls the display apparatus 200 only by operating some control devices (target control devices) among all control devices, the display apparatus 200 hides focuses of other control devices, in order to prevent presentation of the corresponding focuses of the other control devices from interfering with the user's observation of the focuses of the target control devices. As shown in FIG. 27, both the first focus 703 and the focus A1001 are presented on the user interface of the browser. The user currently controls the display apparatus 200 only by operating the remote control without operating the mouse. As shown in FIG. 30, only the first focus 703 is presented, and the focus A1001 is hidden (shown by dotted lines). The specific steps are discussed as follows.

The display apparatus 200 calculates a corresponding idle time length for each control device 100. The idle time length refers to a time length from last receipt of a command from the control device 100 to the current moment of the display apparatus. For example, the display apparatus 200 may create a corresponding timer for each control device 100, and re-start upon receipt of a command every time. The display apparatus 200 detects the idle time length of each control device 100, hides a corresponding focus of a corresponding control device 100 when the idle time length is greater than or equal to a preset time length, presents the focus of the control device 100 upon next receipt of a command sent from the control device 100, and restarts timing. In this way, focuses of the control devices 100 will still be presented on the user interface of the browser within a preset time length, so that the user can know about position information of the focuses of the control devices 100 during this time period. When an idle time length of one of the control devices 100 exceeds the preset time length, it means that the user does not use the control device 100 for a long time, such that a corresponding focus of the control device 100 is hidden, to prevent presentation of the corresponding focus of the control device 100 from affecting the user's observation of focuses of other control devices 100. At the same time, after receiving the command sent from the control device 100, the display apparatus 200 presents the hidden focus of the control device 100, so that the user can promptly observe a corresponding position of the control device 100 on the user interface of the browser, and so that the user can continue to give a command.

In response to the above commands associated with starting of the multi-device control function, such as the first start command, a confirmation command for instructing to select the second control device, a command for configuring a focus style, etc., the display apparatus 200 stores corresponding configuration data to record a current device control state of the display apparatus 200, a control device involved in the multi-device control, and focus information of a corresponding focus. In the display apparatus, in a multi-focus scenario, location information of each focus (for example, a coordinate of each focus) is stored in the display apparatus. The multiple focuses are independent of each other and each focus is located in its corresponding window or split screen.

The display apparatus 200 stores configuration data corresponding to the multi-device control option in the setting menu as shown in FIG. 25 in local storage of the display apparatus, for example, stores browser pattern data in state. Browser Equipment Data, such as a multi-device identifier “true” (indicating that the multi-device control function is started) or “false” (indicating that the multi-device control function is closed) in local storage of the browser, and stores corresponding focus information of each control device, such as identifier information of a focus, and a corresponding relationship between focuses and control devices. In an example, the data in the local storage is in a string form and has no expiration date unless the data is deleted manually or cleared in a factory reset process. The identifier information of a focus is used for uniquely identify the focus, and may be a reference numeral, a name, etc., such as a first focus, a second focus, etc. The corresponding relationship between focuses and control devices may be expressed as data pairs of identifier information of the focuses and identifier information of the control devices, for example, a corresponding relationship between the first focus 703 and the first control device 704 may be expressed as “first focus-remote control”; a corresponding relationship between the second focus and the second control device, such as a corresponding relationship between the focus A1001 and the control device A705, may be expressed as “second1 focus-mouse,” and a corresponding relationship between the focus B1101 and the control device B706 may be expressed as “second2 focus-keyboard.”

In some embodiments, if the user does not log in a user account, the above configuration data is stored in the local storage of the browser; while if the user logs in a user account, the above configuration data is stored in the local storage of the browser, and the storage address of the configuration data is associated with a user ID of the user account, to associate the stored configuration data with the user account.

In some embodiments, when the user logs in the user account, the user can upload the configuration data to a cloud server for storage, where a storage address of the configuration data in the cloud server is associated with the user account. Therefore, after logging in the user account on other display devices, the user can acquire the stored configuration data from the cloud server, and set the browser on a current display apparatus using the acquired configuration data, to synchronize browser settings on different display devices based on the same user account.

The processes shown in FIG. 31 may be referred to for the process that the user moves a corresponding focus on the user interface of the browser by operating multiple control devices, and the specific steps are discussed as follows.

S1401: receiving a first focus move command from the user, where the first focus move command is used for indicating a target control device, a target move direction of a target focus corresponding to the target control device, and a target move distance of the target focus along the target move direction.

A first focus move command is input to the display apparatus 200 by operating the control device 100, where the first focus move command is used for indicating a control device sending the first focus move command, i.e., the target control device, for example, identifier information for indicating the target control device. In this embodiment, the target control device may be the first control device (indicating to only move the first focus corresponding to the first control device), or may be the second control device (indicating to only move the second focus corresponding to the second control device), or may be the first control device and the second control device (indicating to simultaneously move the first focus corresponding to the first control device and the second focus corresponding to the second control device).

The first focus move command further indicates the target move direction of the target focus corresponding to the target control device and the target move distance of the target focus in the target move direction. For example, if the target control device is the first control device, the target focus is the first focus. If the target control device is the first control device and the second control device, the target focus is the first focus and the second focus.

The target move direction of the target focus includes a horizontal direction and a longitudinal direction. For example, if the target control device is a remote control, the key values “left” and “right” represent the horizontal direction, and the key values “up” and “down” represent the longitudinal direction. If the target control device is the mouse, the move directions “leftward” and “rightward” of the mouse represent the horizontal direction, and the move directions “upward” and “downward” of the mouse represent the longitudinal direction. If the target control device is a keyboard, the key values “left” and “right” represent the horizontal direction, and the key values “up” and “down” represent the longitudinal direction.

The target distance includes a positive value and a negative value, where when the target distance is a positive value, it means to move by the distance value in a positive direction of the target move direction, and when the target distance is a negative value, it means to move by the distance value in a negative direction of the target move direction. For example, the target move direction is the horizontal direction; if the target distance is 30 mm, the target focus moves by 30 mm in the positive direction of the horizontal direction; and if the target distance is-20 mm, the target focus moves by 20 mm in the negative direction of the horizontal direction.

S1402: in response to the first focus move command, acquiring a current position coordinate of the target focus.

A focus style container is configured within the display apparatus 200, and each focus style container corresponds to a pair of a control device and a focus corresponding to the control device. A function of responding to the first focus move command is added to the focus style container, i.e., the display apparatus 200 responds to the first focus move command sent from the target control device through the focus style container corresponding to the target control device, and moves the focus style container to move the target focus. The focus style container is processed in the Direct Frame Buffer (DFB) in the middle ware layer. For example, upon receipt of an event associated with a mouse, web engine located between upper layer TV browser and underlying browser (for example Odin browser) uses DFB to monitor this event associated with the mouse and notify upper layer browser location of a current focus associated with this event to perform an operation for the current focus as a reply to the event. DFB buffer will send location information of the current focus to the upper layer browser as to determine a presentation style for the focus. First, after receiving the first focus move command, the display apparatus 200 determines a focus style container corresponding to the selected focus, i.e., the target focus style container, based on the target control device indicated by the first focus move command. The display apparatus 200 obtains current position coordinate of the target focus style container to determine the current position coordinate of the target focus, and takes the position coordinate as a starting point of subsequent movement.

S1403: moving the target focus by a corresponding target distance in the target move direction with the current position coordinate of the target focus as a starting point. When a corresponding position coordinate of the target focus after movement by the target distance is greater than or equal to a coordinate range of a window where the target focus is located, the target focus is presented at a boundary of the window where the target focus is located.

The display apparatus 200 moves the target focus according to the target move direction and the target distance indicated in the first focus move command with the current position coordinate of the target focus as the starting point. For example, the current position coordinate of the target focus is (50, 50), the target move direction includes a horizontal direction and a longitudinal direction, the target move distance in the horizontal direction is 30 mm, the target move distance in the longitudinal direction is-20 mm, and the position coordinate of the target focus after movement is (80, 30).

In some embodiments, in order to cause the target focus move smoothly, an animation function is added to the focus style container, to show continuous move of the target focus from the position coordinate at the starting point to the destination position coordinate after movement, and avoid a phenomenon that the target focus disappears from the position coordinate at the starting point and is directly presented at the destination position coordinate suddenly.

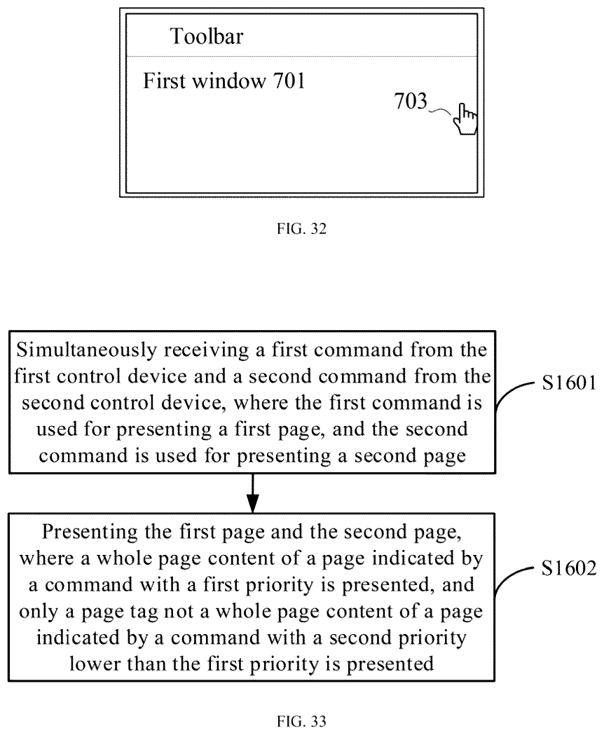

In some embodiments, a move range for the target focus is added. For example, the user interface of the browser has a certain range, i.e., four boundaries of the user interface of the browser. The range is converted into coordinate representation. For example, the lower left corner of the user interface of the browser is the origin (0, 0), the upper left corner of the user interface of the browser is (0, 80), the lower right corner of the user interface of the browser is (100, 0), and the upper right corner of the user interface of the browser is (100, 80). The four boundaries composing the four vertexes are the range of the user interface of the browser. Movement of the target focus on the user interface of the browser is restricted, to prevent the problem of losing focus caused by move of the target focus beyond an area of the user interface of the browser. Once the destination position coordinate of the target focus after movement are beyond the range of the user interface of the browser, when the target focus moves, the target focus stops moving when moving to a corresponding boundary, and is presented at the boundary. As shown in FIG. 32, for example, the first focus 703 is the target focus, when the first focus 703 moves to the right boundary of the first window 701, the first focus 703 does not continue moving in response to the first focus move command, and the first focus 703 is presented at the right boundary of the first window 701.

When the user simultaneously controls the first control device and the second control device to send a command for presenting a corresponding page to the display apparatus 200, a plurality of commands can be responded to with reference to the processes shown in FIG. 33, and the specific steps are discussed as follows.

S1601: simultaneously receiving a first command from the first control device and a second command from the second control device, where the first command is used for presenting a first page, and the second command is used for presenting a second page, where there is a response priority between the first command and the second command.

Multi-focus control is supported by the underlying browser, and bidirectional communication is established between the underlying browser and the upper layer browser. The upper layer browser receives a command sent from a control device, acquires a position coordinate of a focus, and sends the received command and the position coordinate of the focus to the underlying browser in real time through a long link. Web engine is located between the underlying browser and the upper layer browser. The underlying browser generates result data based on the received command and the position coordinate of the focus, and sends the result data to the upper layer browser through a long link, to display the result data through the upper layer browser, and complete response to the command. For example, the communication data includes the position coordinate of the focus, identifier information of the focus, an event type corresponding to the focus, such as clicking, moving in, moving out, etc., and button information of each control device, such as an enter button of the keyboard, a left button of the mouse, the OK button of the remote control, etc.

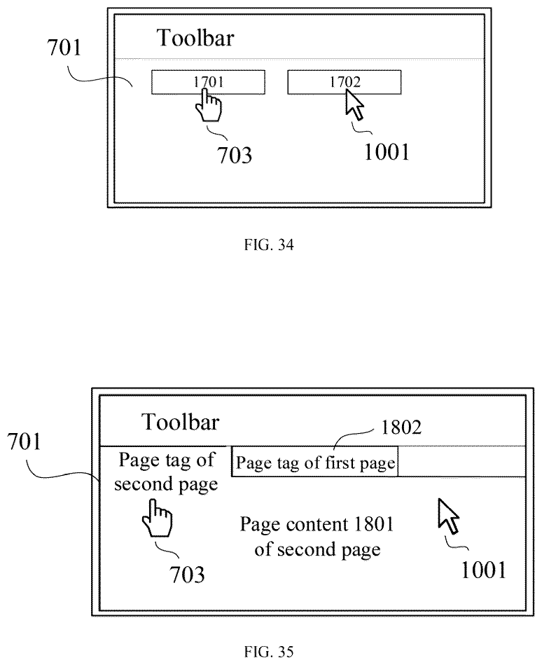

In this embodiment, the first command and the second command are sent from the first control device and the second control device respectively, and are both used for instructing to open a corresponding page. For example, as shown in FIG. 34, the user moves the first focus 703 to an entrance 1701 of the first page by operating the first control device 704, such as the remote control, and the user moves the second focus, namely the focus A1001, to an entrance 1702 of the second page by operating the second control device, such as the control device A705 in the above examples, namely the mouse, a first command is input to the display apparatus 200 via selection of “OK” button on the remote control, and meanwhile or almost at the same time, a second command is input to the display apparatus 200 by selection of the left button of the mouse. Thus, the display apparatus 200 will substantially simultaneously receive the first command and the second command.

In response to the first command, the display apparatus 200 acquires first position coordinate of the first focus through the browser, and in response to the second command, the display apparatus 200 acquires second position coordinate of the second focus through the browser. The browser sends the acquired first position coordinate, the acquired second position coordinate, the corresponding first command, and the corresponding second command to the underlying browser for data processing.

S1602: presenting the first page and the second page, where a whole page content of a page indicated by a command with a first priority is presented, and only a page tag not a whole page content of a page indicated by a command with a second priority lower than the first priority is presented.

Since the user interface of the browser only includes one display window, namely the first window, in order to ensure effective display of the page content, response priorities are set for commands sent from the control devices, where the page content of the page indicated by the command with the first priority higher than the second priority is preferentially presented, and a page content of the page indicated by the command with the second priority is not presented wholly or fully, i.e., the page is in an unactivated state, and only the page tag of the page is presented, thereby avoiding the computational burden of acquiring page data of a plurality of pages at the same time and the mess of simultaneous display, and presenting a page tag of a page without presenting the whole page content, to show the response result to the user through the page tag, avoid occurrence of no response.

If the response priority of the second command is higher, and the response priority of the first command is lower, as shown in FIG. 35, a whole page content 1801 of the second page is preferentially presented, a whole page content of the first page is not presented, a page tag 1802 of the first page is presented instead.

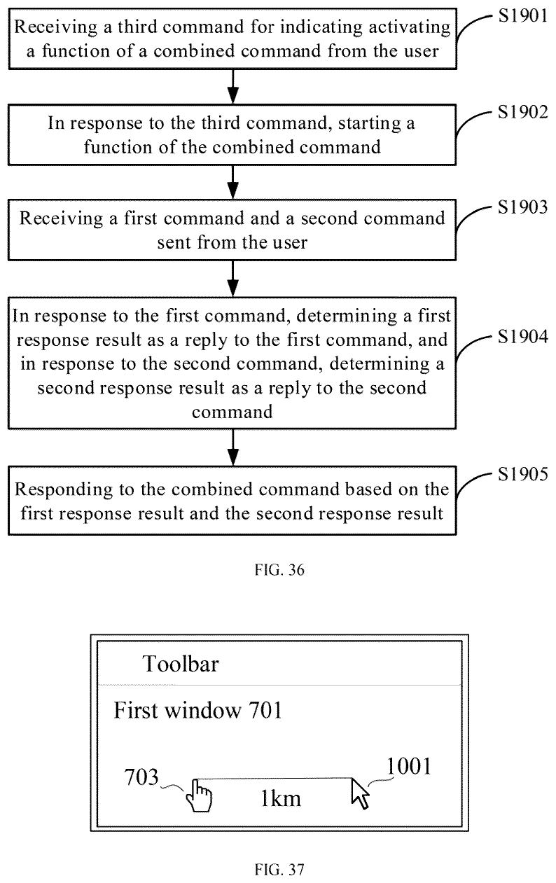

In some embodiments, based on the multi-device control function, a combined command can be sent through multiple devices to expand the function of the browser. Referring to the processes shown in FIG. 36, the specific steps are discussed as follows.

S1901: receiving a third command for indicating activating a function of a combined command from the user, where the combined command includes a first command and a second command, the first command is used for indicating the first focus, and the second command is used for indicating the second focus.

The setting menu further includes a combined command option, by combining commands sent from different control devices, such as the first command and the second command, to obtain a combined command corresponding to a specific function, where the first command corresponds to the first focus, and the second command corresponds to the second focus.

By controlling a currently used control device (the first control device or the second control device), the user moves the focus to the combined command option in the setting menu. The user sends a confirmation command through the currently used control device to instruct the display apparatus 200 to activate the function of the combined command.

In some embodiments, if a currently presented page of the browser does not support the function of the combined command, the combined command option in the setting menu is grayed to indicate that the function of the combined command is not available for the current page. If the currently presented page of the browser supports the function of the combined command, the combined command option in the setting menu is in an available state.

S1902: in response to the third command, starting a function of the combined command.

When the display apparatus 200 receives a confirmation command, and recognizes that the focus is on the combined command option, and the combined command option is currently in the available state, the confirmation command is determined to be the third command, and, in response to the third command, the function of the combined command is started. In some embodiments, the combined command includes a command for measuring a distance between two points, a 3D rotation command, and the like.

S1903: receiving a first command and a second command sent from the user.

In some embodiments, the combined command is a command for measuring a distance between two points, the first command is used for acquiring position coordinate of the first focus and the second command is used for acquiring position coordinate of the second focus.

In some embodiments, the combined command is a 3D rotation command, the first command is used for acquiring the position coordinate of the first focus, and the second command is used for rotating around the first focus according to the move direction of the second focus.

S1904: in response to the first command, determining a first response result as a reply to the first command, and in response to the second command, determining a second response result as a reply to the second command.

Corresponding to S1903, in some embodiments, the combined command is a command for measuring a distance between two points; in response to the first command, the position coordinate of the first focus, namely the first response result, are acquired; and in response to the second command, the position coordinate of the second focus, namely the second response result, are acquired.

In some embodiments, the combined command is a 3D rotation command; in response to the first command, the position coordinate of the first focus, namely the first response result, are acquired; and in response to the second command, rotation is performed around the first focus according to the move direction of the second focus, namely the second response result.

S1905: responding to the combined command based on the first response result and the second response result.

Based on the first response result and the second response result, the combined command comprising the first command and the second command is responded to.

In some embodiments, the combined command is a command for measuring a distance between two points. Based on the first response result, namely the position coordinate of the first focus, and the second response result, namely the position coordinate of the second focus, a distance between two points can be obtained by computing a coordinate distance between the first focus and the second focus and multiplying the coordinate distance by a corresponding ratio, and is marked between the first focus and the second focus, as shown in FIG. 37. For example, for the first focus 703, the second focus, and the focus A1001, a distance between two points is obtained as 1 km by the above measuring process, and 1 km is denoted between the two points. This command can be used for distance measurement between two points on a page within the browser, such as a map, using two control devices, and the operations are simpler and faster.

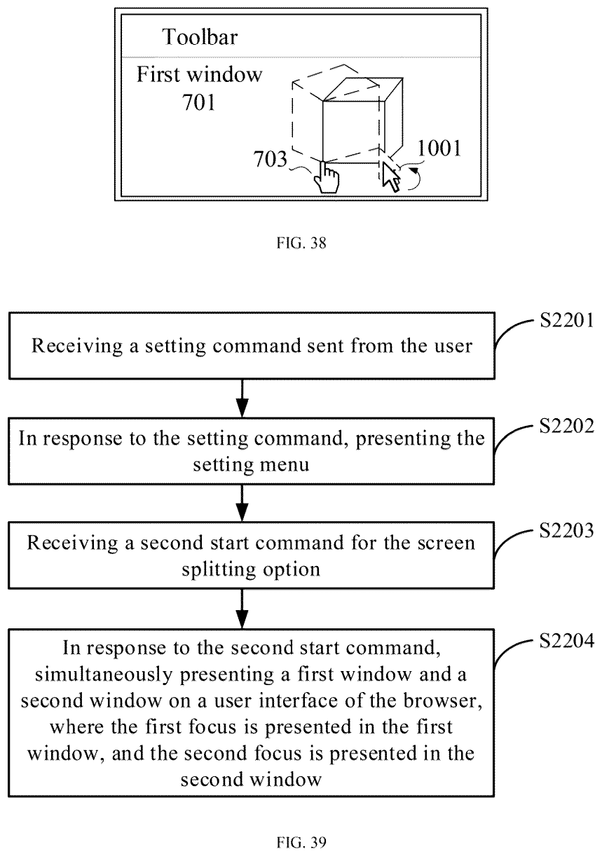

In some embodiments, the combined command is a 3D rotation command, and based on the first response result, namely the position coordinate of the first focus, and the second response result, i.e., performing rotation around the first focus according to the move direction of the second focus, namely the second response result, a current page of the browser is rotated by acquiring the move direction of the second focus in combination with the position coordinate of the first focus. As shown in FIG. 38, for example, for the first focus 703, the second focus, and the focus A1001, the user controls the control device A705 to rotate the mouse counterclockwise around the first focus 703, i.e., the move direction of the focus A1001 is counterclockwise rotation, so that a graphic on the page rotates counterclockwise around the focus 703 (the graphic after rotation is shown by dotted lines). With the 3D rotation command, a page within the browser, such as a space diagram, an indoor structural diagram, etc., can be rotated and presented using two control devices.

After the display apparatus starts a function of simultaneously controlling the display apparatus by multiple control devices, when simultaneous connection with the multiple control devices is detected, multiple focuses is simultaneously presented on the user interface of the browser, where each focus corresponds to one of the control devices, and different focuses correspond to different control devices. The display apparatus can simultaneously respond to commands sent from multiple control devices based on corresponding focuses, so that the multiple control devices simultaneously controlling of the display apparatus is realized.

In some embodiments, in order to realize control different windows of the browser respectively by simultaneously operating multiple control devices, or multiple users can simultaneously use the browser, a screen splitting function of the browser can be started. Referring to the processes shown in FIG. 39, the specific steps are as follows.

S2201: receiving a setting command sent from the user.

Based on the above multi-device control function, the user sends a setting command to the display apparatus 200 by operating the currently used control device (the first control device or the second control device). The process of sending the setting command to the display apparatus 200 via the first control device in S601 may be referred to for this process of sending the setting command.

S2202: in response to the setting command, presenting the setting menu, wherein the setting menu further includes a screen splitting option.

The process in S602 may be referred to for the process of presenting the setting menu by the display apparatus 200. As shown in FIG. 25, the setting menu further includes a screen splitting option. The screen splitting option includes two states, on state and off state, where the off state means that the browser only includes one window, namely the first window 701. The on state means that multiple windows of the browser is simultaneously presented, each window is equivalent to an independent browser, and independent search operations can be carried out in each window.

S2203: receiving a second start command for the screen splitting option, where the second start command is used for instructing to start a screen splitting function of the browser.

The user moves a corresponding focus to the screen splitting option by operating the currently used control device (the first control device or the second control device), and instructs to adjust the screen splitting option state to the on state by sending the second start command to the display apparatus 200.

S2204: in response to the second start command, simultaneously presenting a first window and a second window on the user interface of the browser, where the first focus is presented in the first window, and the second focus is presented in the second window.

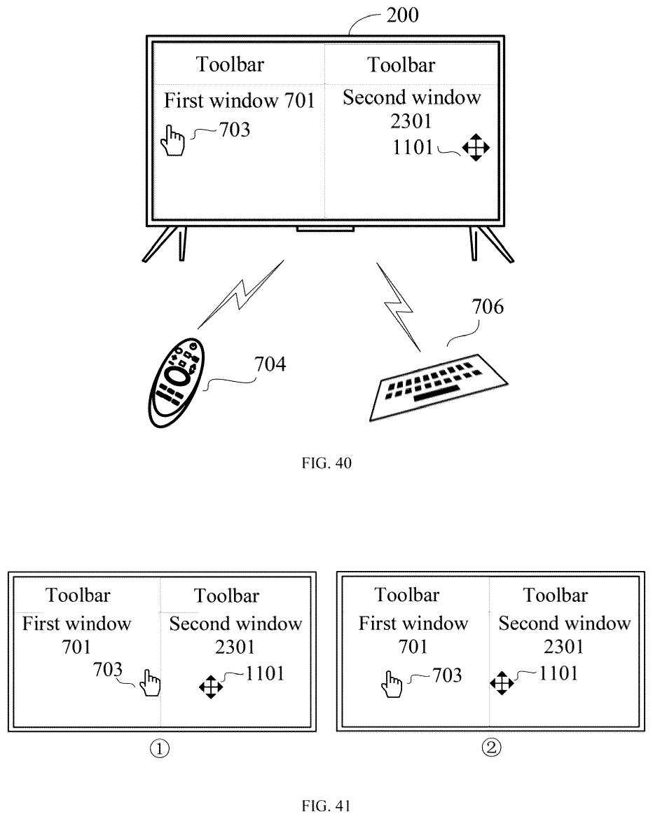

In response to the second start command, the display apparatus 200 creates a new window, namely the second window, on the user interface of the browser, and simultaneously presents the first window 701 and the second window. Each window has a corresponding toolbar to achieve the screen splitting effect. As shown in FIG. 40, the second window 2301 is added to the right side of the first window 701. In some embodiments, the second window 2301 may also be added above, below or to the left side of the first window 701. In order to control each window independently, the first focus and the second focus are presented in each window respectively, to control corresponding windows by different control devices. As shown in FIG. 41, the first focus 703 is presented within the first window, and the second focus, such as the focus B1101 in the above example, is presented within the second window 2301. In this case, the first control device 704 controls the first window 701 of the browser based on the first focus 703, and the second control device, namely the control device B706, controls the second window 2301 of the browser based on the focus B1101. The first focus 703 may also be presented within the second window 2301, and the second focus may also be presented within the first window 701. In this case, the first control device 704 controls the second window 2301 of the browser based on the first focus 703, and the second control device controls the first window 701 of the browser based on the second focus.

Thus, the user can simultaneously control the multiple control devices, to perform network search in different browser windows, and simultaneously present search results, so that a plurality of search results can be compared on the same user interface. The plurality of users can control the corresponding browser windows through their respective control devices, to carry out collaborative operations among the plurality of users, such as a multiplayer game, a multi-party communication, etc.

In response to the above commands associated with starting of the screen splitting function, such as the second start command, the display apparatus 200 stores corresponding configuration data, to record a current browser window state of the display apparatus 200 and focus information within each window.

The display apparatus 200 stores configuration data corresponding to the screen splitting option in the setting menu as shown in FIG. 25 in local storage, for example, stores browser pattern data in state. Browser Equipment Data, such as a split screen identifier “true” (indicating that the screen splitting function is started) or “false” (indicating that the screen splitting function is closed) in local storage of the browser, and stores a correspondence relationship between each window and focus. The correspondence relationship between each window and focus may be expressed as a data pair of focus identifier information and window identifier information. For example, a correspondence relationship between the first focus and the first window may be expressed as “first focus-left”; and a correspondence relationship between the second focus and the second window may be expressed as “second focus-right.”

In some embodiments, if the user does not log in a user account, the above configuration data is stored in the local storage of the browser; while if the user logs in a user account, the above configuration data is stored in the local storage of the browser, and the storage address of the configuration data is associated with a user ID of the user account, to associate the stored configuration data with the user account.

In some embodiments, when the user logs in the user account, the user can upload the configuration data to a cloud server for storage, which will not be repeated here.

In some embodiments, the move process of the target focus in the above S1401-S1403 may be referred to for the move process of the first focus and the second focus within the corresponding windows. The move range of the first focus and the second focus is different from the move range when only one first window is included. In this embodiment, the first focus and the second focus can only move within its corresponding window. For example, in FIG. 40, the first focus 703 can only move within the first window 701, and the focus B1101 can only move within the second window 2301. If a horizontal coordinate of the position coordinate of the first focus 703 after movement is greater than or equal to a horizontal coordinate range of the first window 701, i.e., exceeding a boundary between the first window 701 and the second window 2301, the first focus 703 stops moving when moving to the boundary between the first window 701 and the second window 2301 during the movement, and the first focus 703 is presented at the boundary, as shown in (1) in FIG. 41. If a horizontal coordinate of the position coordinate of the focus B1101 after movement is less than or equal to a horizontal coordinate range of the second window 2301, i.e., exceeding the boundary between the first window 701 and the second window 2301, the focus B1101 stops moving when moving to the boundary between the first window 701 and the second window 2301 during the movement, and the focus B1101 is presented at the boundary, as shown in 2) in FIG. 41.

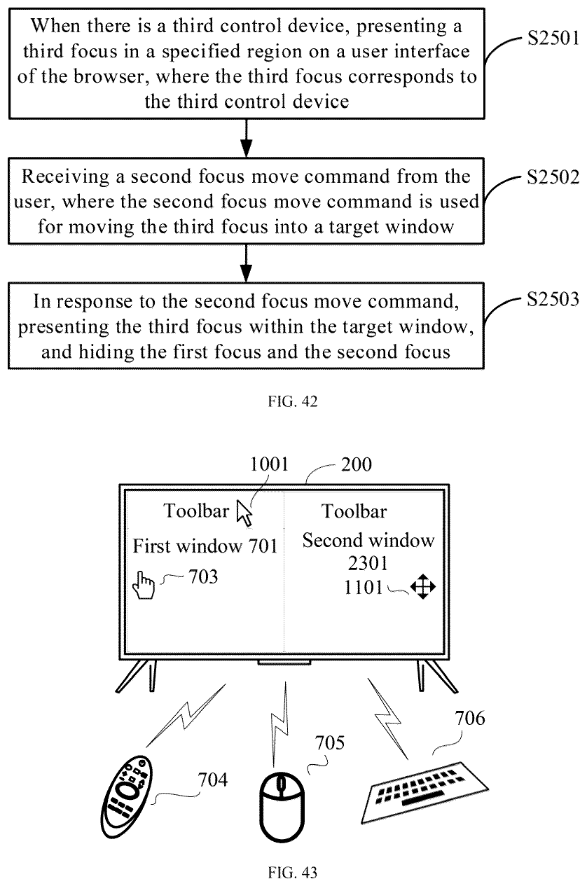

In order to facilitate overall control on the browser in a split screen state, a control device is added, such that a focus of the control device can be presented on the overall user interface of the browser, i.e., the control device can control all windows within the browser. Referring to the processes shown in FIG. 42, the specific steps are discussed as follows.

S2501: when there is a third control device, presenting a third focus in a specified region on the user interface of the browser, where the third focus corresponds to the third control device, and the specified region refers to a region on the user interface of the browser except for the first window and the second window.

When detecting that another control device, namely the third control device, is connected with the display apparatus, the display apparatus 200 first presents a focus corresponding to the third control device, namely the third focus, in a command region on the user interface of the browser, such as a region corresponding to the toolbar of each window. The specified region is configured such that presentation of the first focus and the second focus will not be affected when the third focus is in the specified region. In this case, the first focus in the first window, the second focus in the second window, and the third focus are simultaneously presented on the user interface of the browser. As shown in FIG. 43, the control device A705 is used as the third control device, the first focus 703 is presented in the first window 701, the second focus, such as the focus B1101, is presented in the second window 2301, and the third focus, namely the focus A1001, is presented in the toolbar corresponding to the first window 701.

S2502: receiving a second focus move command from the user, where the second focus move command is used for moving the third focus into a target window, and the target window is the first window or the second window.

In this embodiment, the second focus move command is used for moving the third focus from the specified region into the first window or the second window.

S2503: in response to the second focus move command, presenting the third focus within the target window, and hiding the first focus and the second focus.

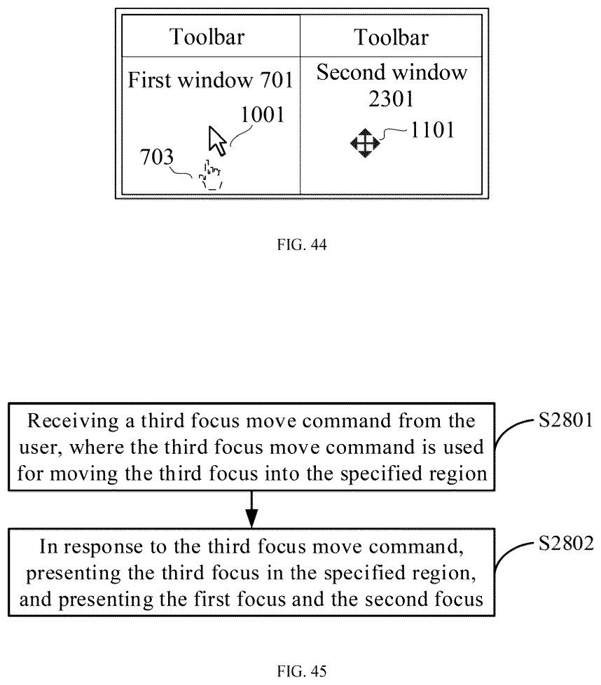

In this embodiment, as shown in FIG. 44, when the third focus, such as the focus A1001, moves into the target window, e.g., moves into the first window 701, the first focus 703 and the focus B1101 will be hidden (shown by dotted lines), and will not be presented, to control movement of the focus A1001 within the target window through the control device A705, and prevent display of the first focus 703 and the focus B1101 from affecting the user's observation of a movement trajectory of the focus A1001, thereby controlling all windows in the browser by the third control device based on the third focus.

When the focus A1001 is detected to move to a junction of the target window and the specified region, current position coordinates of the first focus 703 and the focus B1101 are acquired, and are stored to record positions where the first focus 703 and the focus B1101 are hidden. The stored position coordinates may be directly used subsequently when the first focus 703 and the focus B1101 need to be re-presented.

Referring to the processes shown in FIG. 45, when the third focus re-moves to the specified region, each focus is presented according to the following steps.

S2801: receiving a third focus move command from the user, where the third focus move command is used for moving the third focus into the specified region.

In this embodiment, the third focus move command is used for moving the third focus from the first window or the second window into the specified region.

S2802: in response to the third focus move command, presenting the third focus in the specified region, and presenting the first focus and the second focus.

In this embodiment, as shown in FIG. 43, when the focus A1001 re-moves into the specified region, e.g., moves to the toolbar corresponding to the first window 701, the first focus 703 and the focus B1101 may be re-presented, to recover from simultaneously controlling respective windows of the browser via different control devices based on their respective focuses.

In some embodiments, the setting menu as shown in FIG. 25 further includes options, such as home page setting, advertising switch, version information, historical information, traceless browsing, historical association search, clear cache, etc., which are generally associated with personal preferences of the user. If the user configures the above functional options after logging in the user account, configuration data corresponding to the above functional options is stored, and the storage address of the configuration data is associated with a user ID of the user account, to associate the stored configuration data with the user account. In some embodiments, when the user logs in the user account, the user can upload the above configuration data to a cloud server for storage, which will not be repeated here. If the user configures the above functional options without logging in the user account, configuration data corresponding to the above functional options may not be stored associated with the user ID.

After the display apparatus starts the screen splitting function of the browser, a plurality of windows is simultaneously presented on the user interface of the browser, where one focus is presented in each window, and the display apparatus responds to a command sent from the control device based on a corresponding focus, to control different windows by different control devices. For the convenience of explanation, the above description has been made in combination with specific embodiments. However, the above example discussion is not intended to be exhaustive or to limit embodiments to the specific forms disclosed above. Numerous modifications and variations can be obtained in light of the above teachings. The above embodiments are chosen and described in order to better explain the principles and practical applications, to enable those skilled in the art to better utilize the described embodiments and various variant embodiments suitable for specific uses.

What is claimed is:

1. A display apparatus, comprising:
a display configured to display an image from a broadcasting system or a network, and/or, a user interface; and
a communicating device configured to communicate with the network;
at least one processor in connection with the display and the communicating device and configured to execute instructions to cause the display apparatus to:
in response to a first command for opening a first browser application in the display apparatus from a user, start to load a first web page of the first browser application;
parse the first web page downloaded, to obtain a first document object model tree;
in response to a web page head of the first document object model tree comprising a first meta viewport tag, determine a first resolution of the first web page according to the first meta viewport tag;
determine a first web page scale factor according to a physical resolution of the display apparatus and the first resolution;
relayout, redraw, and rearrange an element on the first web page based on the first web page scale factor to determine a second web page; and
cause the display to present the second web page;
wherein the at least one processor is further configured to execute instructions to cause the display apparatus to:
in response to the element on the first web page being a text control, determine a first coordinate of a specific point of the text control and a first font size of a text on the text control, the specific point comprising a center point or a vertex of the text control;
determine a second coordinate of the specific point of the text control according to the first coordinate of the specific point of the text control and the first web page scale factor;
determine a second font size of the text according to the first font size of the text and the first web page scale factor; and
draw the text control according to the second coordinate and the second font size.

2. The display apparatus according to claim 1, wherein the at least one processor is further configured to execute instructions to cause the display apparatus to:
before parsing the first web page downloaded, determine a window mode corresponding to the first web page; and
determine a second resolution of the first web page according to the window mode.

3. The display apparatus according to claim 2, wherein the at least one processor is further configured to execute instructions to cause the display apparatus to:
in response to the web page head of the first document object model tree not comprising the first meta viewport tag, determine a second web page scale factor according to the physical resolution of the display apparatus and the second resolution;
relayout, redraw, and rearrange the element on the first web page based on the second web page scale factor to obtain a third web page; and
cause the display to present the third web page.

4. The display apparatus according to claim 2, wherein the at least one processor is further configured to execute instructions to cause the display apparatus to:
in response to the web page head of the first document object model tree not comprising the first meta viewport tag, cause the display to present the first web page corresponding to the second resolution.

5. The display apparatus according to claim 1, wherein the at least one processor is further configured to execute instructions to cause the display apparatus to:
in response to the element on the first web page being an image control, determine a first coordinate of a specific point of the image control, a first width of the image control, and a first height of the image control, the specific point comprising a center point or a vertex of the image control;
determine a second coordinate of the specific point of the image control according to the first coordinate of the specific point of the image control and the first web page scale factor;
determine a second width and a second height of the image control according to the first width and the first height of the image control and the first web page scale factor; and
draw the image control according to the second coordinate of the specific point of the image control, the second width and the second height.

6. The display apparatus according to claim 1, wherein the at least one processor is further configured to execute instructions to cause the display apparatus to:
after determining the first resolution of the first web page according to the first meta viewport tag, determine whether the first resolution is same as the physical resolution of the display apparatus;
in response to the first resolution being same as the physical resolution of the display apparatus, cause the display to present the first web page corresponding to the first resolution; and
in response to the second resolution being different from the physical resolution of the display apparatus, determine the first web page scale factor according to the physical resolution of the display apparatus and the first resolution.

7. The display apparatus according to claim 1, wherein the at least one processor is further configured to execute instructions to cause the display apparatus to:
in response to a second command for opening a second browser application in the display apparatus, start to load a fourth web page of the second browser application;
parse the fourth web page download to obtain a second document object model tree;
in response to a web page head of the second document object model tree comprising a second meta viewport tag, determine a third resolution of the fourth web page according to the second meta viewport tag;
determine a third web page scale factor according to the physical resolution of the display apparatus and the third resolution.

8. The display apparatus according to claim 2, wherein the second resolution is determined according to a width value and a height value in the window mode.

9. The display apparatus according to claim 1, wherein the first browser application comprises: an HbbTV application, a Store application or an Open Browser application.

10. A method for processing a web page in a display apparatus, comprising:
in response to a first command for opening a first browser application in the display apparatus input from a user, starting to load a first web page of the first browser application;
parsing the first web page downloaded, to obtain a first document object model tree;
in response to a web page head of the first document object model tree comprising a first meta viewport tag, determining a first resolution of the first web page according to the first meta viewport tag;
determining a first web page scale factor according to a physical resolution of the display apparatus and the first resolution;
relayouting, redrawing, and rearranging an element on the first web page based on the first web page scale factor to determine a second web page; and
causing a display to present the second web page;
wherein the relayouting, redrawing, and rearranging the element on the first web page comprises:
in response to the element on the first web page being a text control, determining a first coordinate of a specific point of the text control and a first font size of a text on the text control, the specific point comprising a center point or a vertex of the text control;
determining a second coordinate of the specific point of the text control according to the first coordinate of the specific point of the text control and the first web page scale factor;
determining a second font size of the text according to the first font size of the text and the first web page scale factor; and
drawing the text control according to the second coordinate and the second font size.

11. The method according to claim 10, wherein before parsing the first web page downloaded, the method further comprises:
determining a window mode corresponding to the first web page, and determining a second resolution of the first web page according to the window mode.

12. The method according to claim 11, wherein the method further comprises:
in response to the web page head of the first document object model tree not comprising the first meta viewport tag, determining a second web page scale factor according to the physical resolution of the display apparatus and the second resolution;
relayouting, redrawing, and rearranging the element on the first web page based on the second web page scale factor to obtain a third web page; and
causing the display to present the third web page.

13. The method according to claim 11, wherein the method further comprises:
in response to the web page head of the first document object model tree not comprising the first meta viewport tag, causing the display to present the first web page corresponding to the second resolution.

14. The method according to claim 10, wherein the relayouting, redrawing, and rearranging the element on the first web page comprises:
in response to the element on the first web page being an image control, determining a first coordinate of a specific point of the image control, a first width of the image control, and a first height of the image control, the specific point comprising a center point or a vertex of the image control;
determining a second coordinate of the specific point of the image control according to the first coordinate of the specific point of the image control and the first web page scale factor;
determining a second width and a second height of the image control according to the first width and the first height of the image control and the first web page scale factor; and
drawing the image control according to the second coordinate of the specific point of the image control, the second width and the second height.

15. The method according to claim 10, wherein after determining the first resolution of the first web page according to the first meta viewport tag, the method further comprises:
determining whether the first resolution is same as the physical resolution of the display apparatus;
in response to the first resolution being same as the physical resolution of the display apparatus, causing the display to present the first web page corresponding to the first resolution; and
in response to the second resolution being different from the physical resolution of the display apparatus, determining the first web page scale factor according to the physical resolution of the display apparatus and the first resolution.

16. The method according to claim 10, wherein the method further comprises:
in response to a second command for opening a second browser application in the display apparatus, starting to load a fourth web page of the second browser application;
parsing the fourth web page download to obtain a second document object model tree;
in response to a web page head of the second document object model tree comprising a second meta viewport tag, determining a third resolution of the fourth web page according to the second meta viewport tag;
determining a third web page scale factor according to the physical resolution of the display apparatus and the third resolution.

17. The method according to claim 11, wherein the second resolution is determined according to a width value and a height value in the window mode.

18. The method according to claim 10, wherein the first browser application comprises: an HbbTV application, a Store application or an Open Browser application.
